(19) United States
(12) Patent Application Publication
(10) Pub. No.: US 2018/0248902 A1
(43) Pub. Date: Aug. 30, 2018

(54) MALICIOUS ACTIVITY DETECTION ON A COMPUTER NETWORK AND NETWORK METADATA NORMALISATION

(71) Applicants: Mircea DÃNILÃ-DUMITRESCU, London, Greater London (GB); Ankur MODI, London, Greater London (GB)

(72) Inventors: Mircea DÃNILÃ-DUMITRESCU, London, Greater London (GB); Ankur MODI, London, Greater London (GB)

(21) Appl. No.: 15/756,065

(22) PCT Filed: Aug. 30, 2016
(86) PCT No.: PCT/GB2016/052683

§ 371 Date: Feb. 28, 2018

(30) Foreign Application Priority Data
Aug. 28, 2015 (GB) 1515383.6
Aug. 28, 2015 (GB) 1515388.5

(51) Int. Cl. H04L 29/06; G06F 21/55; H04L 29/08; G06N 3/02

(52) U.S. Cl. CPC H04L 63/1425; H04L 63/1416; G06N 3/02; H04L 67/22; G06F 21/552

(57) ABSTRACT

The invention relates to a network security and data normalisation system for a computer network, IT system or infrastructure, or similar. According to an aspect, there is provided a method for identifying abnormal user interactions within one or more monitored computer networks, comprising the steps of: receiving metadata from one or more devices within the one or more monitored computer networks; identifying from the metadata events corresponding to a plurality of user interactions with the monitored computer networks; storing user interaction event data from the identified said events corresponding to a plurality of user interactions with the monitored computer networks; updating a probabilistic model of expected user interactions from said stored user interaction event data; and testing each of said plurality of user interactions with the monitored computer networks against said probabilistic model to identify abnormal user interactions.

### FIELD OF THE INVENTION

The invention relates to a network security and data normalisation system for a computer network, IT system or infrastructure, or similar.

### BACKGROUND

Privacy and confidentiality are a concern when analysing and reconstructing the interaction of a human with an electronic system, including for example interaction with devices and IT systems. Often an abundance of log data is automatically generated by a wide range of devices and IT systems involved in such an interaction. Log data typically only provides a very narrow set of information, but generally does not contain private or confidential data.

Furthermore, preventing unauthorised access to computers and computer networks is a major concern for many companies, public bodies, and other organisations. Malicious third parties can cause damage to data and software resulting in large costs to reverse such damage, and which may lead to reputational damage and/or even physical damage where the malicious third parties gain access to IT systems and then steal data, information or software and/or manipulate systems, software or data. As a response to this threat from malicious third parties, a wide variety of countermeasures have been developed, including software and hardware network perimeter security systems such as firewalls and intrusion detection systems, cryptography and hardware-based two-factor security measures and an emphasis on ‘security by design.’

All of these countermeasures, however, can fail to adequately respond to the situation where a malicious user already has access to a computer system or network, whether they are already a legitimate user or are masquerading as a legitimate user and therefore have authentic access credentials. Many security breaches of this type are almost impossible to stop with conventional countermeasures because the user appears legitimate—typically the user has any required access credentials, such as usernames and passwords, and has the required user permissions to perform harmful actions. The size and complexity of many organisations' networks makes effective monitoring for this form of threat within a network very difficult, as there is a need to capture all relevant information and identify malicious users while avoiding a large number of false positive results that may prevent legitimate users using the computer system or network as intended. Privacy and confidentiality concerns may also increase the difficulty in effectively monitoring such computer systems or networks. The present invention seeks at least to alleviate partially at least some of the above problems.

### SUMMARY OF INVENTION

Aspects and embodiments are set out in the appended claims. These and other aspects and embodiments are also described herein.

According to a first aspect, there is provided a method for identifying abnormal user interactions within one or more monitored computer networks, comprising the steps of: receiving metadata from one or more devices within the one or more monitored computer networks; identifying from the metadata events corresponding to a plurality of user interactions with the monitored computer networks; extracting relevant parameters from the metadata and mapping said relevant parameters to a common data schema, thereby creating normalised user interaction data; storing the normalised user interaction event data from the identified said events corresponding to a plurality of user interactions with the monitored computer networks; testing the normalised user interaction event data against a probabilistic model of expected user interactions to identify abnormal user interactions; and updating said probabilistic model from said stored user interaction event data.

The use of a probabilistic model allows existing users' actions to be compared against a model of their probable or expected actions, and the probabilistic model can be dynamic, enabling identification of malicious users of the monitored computer network or system. A large volume of input data can be used with the method and the model can be updated with user interactions to provide a dynamic model that is updated to generate a model of user interactions. The use of metadata related to user interactions (as encapsulated in log files, for example, which are typically already generated by devices and/or applications) means that a vast amount of data related to human interaction events can be obtained without needing to provide means to monitor the substantive content of user interactions with the system, which may be intrusive and difficult to set-up due to the volume of data that would then need to be processed. The term ‘metadata’ as used herein can be used to refer to log data and/or log metadata.

Optionally, the probabilistic model comprises one or more predetermined models developed from previously identified malicious user interaction scenarios and is operable to identify malicious user interactions.

The use of predetermined models as part of the probabilistic model can provide a further way of detecting malicious users inside the monitored computer network, allowing threatening scenarios that may or may not otherwise be determined as particularly abnormal to be detected. Testing for both abnormal behaviour and identifiably malicious behaviour separately can improve the chances that security breaches can be detected.

Optionally, said user interaction event data comprises any or a combination of: data related to a user involved in an event; data related to an action performed in an event; and/or data related to a device and/or application involved in an event. Optionally, said common data schema comprises: data identifying an action performed in an event; and data identifying a user involved in an event and/or data identifying a device and/or application involved in an event. Optionally, said common data schema further comprises any or a combination of: data related to the or a user involved in an event; data related to the or an action performed in an event; and/or data related to the or a device and/or application involved in an event. Optionally, the mapping comprises looking up a metadata schema and allocating the extracted relevant parameters to the common data schema on the basis of the metadata schema.

Organising data originating from metadata into a set of standardised database fields, for example into subject, verb, and object fields in a database, can allow data to be processed efficiently subsequently in terms of discrete events, and such a data structure can also allow associations to be made earlier between specific ‘subjects’ (such as users), ‘verbs’ (such as actions), and/or ‘objects’ (such as devices and/or applications), improving the usability of the data available.

Optionally, identifying from the metadata events corresponding to a plurality of user interactions with the monitored computer networks comprises extracting relevant parameters from computer and/or network device metadata and mapping said relevant parameters to a common data schema.

Mapping relevant parameters from metadata, for example log files, to or into a common data schema and format can make it possible for this normalised data to be compared more efficiently and/or faster.

Optionally, the method further comprises storing contextual data, wherein said contextual data is related to a user interaction event and/or any of: a user, an action, or an object involved in said event. Optionally, the method comprises the further step of storing contextual data, wherein said contextual data is related to a user interaction event and/or any of: a user, an action, or an object involved in said event

Contextual data, such as information about the user for example as job role and work/usage patterns, can be stored for later use to provide situational insights and assumptions that would not be apparent from the metadata, such as log files, alone. In particular, the contextual data stored can be that determined to be relevant by human and organisational psychology principles, which in turn may be used to explain or contextualise detected behaviours, which can assist to more accurately identify abnormal and/or malicious behaviour.

Optionally, identifying from the metadata events corresponding to a plurality of user interactions further comprises identifying additional parameters by reference to contextual data. Optionally, the contextual data comprises data related to any one or more of: identity data, job roles, psychological profiles, risk ratings, working or usage patterns, action permissibility, and/or times and dates of events.

Contextual data such as identity data can be used to add additional parameters into data, which can enhance or increase the amount of data available about a particular event.

Optionally, the method further comprises testing the normalised user interaction event data against heuristics related to contextual data to identify abnormal and/or malicious user interactions.

The use of heuristics, for example predetermined heuristics based on psychological principles or insights, can allow for factors that may not be easily quantifiable to be taken into greater account, which can improve recognition of scenarios that may indicate malicious behaviour.

Optionally, a trained artificial neural network is used to the normalised user interaction event data against the one or more predetermined models developed from previously identified malicious user interaction scenarios and the heuristics related to contextual data.

Artificial neural networks can be adaptive based on incoming data and can be pre-trained, or trained on an on-going basis, to recognise user behaviours that approximate predetermined or identified malicious scenarios.

Optionally, the normalised user interaction event data and contextual data are stored in a graph database.

The use of a graph database can allow for stored data to be updated and modified efficiently and can specifically allow for improved efficiency when storing or querying of relationships between events or other data.

Optionally, the method further comprises storing metadata and/or the relevant parameters therefrom in an index database.

Storing primary data such as the metadata, for example raw logs and/or extracted parameters, can be useful for auditing purposes and allowing checks to be made against any outputs.

Optionally, testing the normalised user interaction event data against said probabilistic model comprises performing continuous time analysis.

Performing analysis in continuous time (as opposed to discrete time) may allow for relative time differences between user interaction events to be more accurately computed.

Optionally, the method further comprises testing two or more sets of normalised user interaction event data against said probabilistic model to identify abnormal user interactions. Optionally, the method further comprises determining whether said two or more of the plurality of user interactions are part of an identifiable sequence of user interactions indicating user behaviour in performing an activity.

Identifying chains of user behaviour may assist in putting events in context, allowing for improved insights about user behaviour to be made.

Optionally, the method further comprises testing two or more of said plurality of user interactions in combination against said probabilistic model to identify abnormal user interactions.

Testing events in combination allows for single events to be set in the context of related events rather than just historic events. This may provide greater insight, such as by showing that apparently abnormal events are part of a local trend.

Optionally, the time difference between two or more of the sets of normalised user interaction event data is tested. Optionally, the time difference is tested against the time difference of related historic user interactions.

Testing the time difference may allow for events to be reliably assembled in their correct sequence. Additionally, distinctive time differences commonly detectable in certain types of event or situations for a particular user or device may be taken into account when testing for abnormality/maliciousness.

Optionally, the method comprises the further step of analysing the normalised user interaction data using a further one or more probabilistic model, the results of the probabilistic models being analysed by a higher level probabilistic model to identify higher level abnormal user interactions.

Providing a higher level probabilistic model allows for deeper insights to be drawn out of the data.

Optionally, receiving metadata comprises aggregating metadata at a single entry point.

The use of a single entry point to any system implementing the method minimises the potential for malicious users or third parties tampering with metadata such as log files and lowers latency associated with transmission of metadata, which can improve the time taken to process the metadata.

Optionally, metadata is received at the device via one or more of a third party server instance, a client server within one or more computer networks, or a direct link with the one or more devices.

Using any of, a combination of or all of a third party server instance, a client server within one or more computer networks, or a direct link with the one or more devices allows for a variety of different types of metadata to be used, while minimising time associated with metadata transmission.

Optionally, each of the sets of normalised user interaction event data are tested for abnormality substantially immediately following said normalised user interaction event data being stored.

Testing for abnormality as soon as possible can allow system breaches to be detected with minimal delay, which then allows for alerts to be issued to administrators of the system or for automated actions to be taken to curtail or stop the detected breach.

Optionally, normalised user interaction event data is tested for abnormality according to a predetermined schedule in parallel with other tests. Optionally, testing for abnormality according to a predetermined schedule comprises analysing all available normalised user interaction event data corresponding to a plurality of user interactions with the monitored computer networks, wherein said plurality of user interactions occurred within a predetermined time period.

Scheduled processing ensures that metadata which is received some time after being generated can be processed in combination with metadata received in substantially real-time, or can be processed with the context of metadata received in substantially real-time, and can be processed taking into account the transmission and processing delay. Processing this later-received metadata can improve detection of malicious behaviour which may not be apparent from processing of solely the substantially real-time metadata.

Optionally, the method further comprises calculating a score for each of the normalised user interaction event data based on one or more tests.

Calculating a score for each interaction and combinations of interactions can allow for the confidence with which user interactions are classified as abnormal and/or malicious to be assessed and/or relatively ranked.

Optionally, the method further comprises classifying normalised user interaction event data based on a comparison of calculated scores for normalised user interaction event data in combination with one or more predetermined or dynamically calculated thresholds.

Classification based on thresholds allows for various classes of user interactions to be handled differently in further processing or reporting, improving processing efficiency as a whole and allowing prioritisation to occur.

Optionally, the method further comprises prioritising any identified abnormal and/or malicious user interactions using calculated scores and the potential impact of the identified abnormal and/or malicious user interactions.

Prioritising abnormal and/or malicious behaviour can allow generation of prioritised lists of identified abnormal or malicious user interactions for administrators of a system or network, such that resources within an organisation may be more effectively used to investigate the identified abnormal or malicious user interactions by reviewing the list of identified abnormal or malicious user interactions provided in priority order.

Optionally, the scores are calculated in additional dependence on one or more correlations between identified abnormal and/or malicious user interactions and one or more user interactions involving the user, action, and/or object involved in the identified abnormal and/or malicious user interactions.

Events can be compared with other events in an attempt to find relationships between events, which relationships may indicate a sequence of malicious events or malicious behaviour.

Optionally, the method further comprises reporting identified abnormal and/or malicious user interactions.

Reporting identified abnormal and/or malicious user interactions can be used to alert specific users or groups of users, for example network or system administrators, security personnel or management personnel, about interactions in substantially real-time or in condensed reports at regular intervals.

Optionally, the method further comprises implementing precautionary measures in response to one or more identified abnormal and/or malicious user interactions, said precautionary measures comprising one or more of: issuing an alert, issuing a block on a user or device or a session involving said user or device, saving data, and/or performing a custom programmable action.

The optional use of precautionary measures allows for automatic and immediate response to any immediately identifiable threats (such as system breaches), which may stop or at least hinder any breaches.

Optionally, the method further comprises receiving feedback related to the accuracy of the identification of the abnormal and/or malicious user interactions and updating the probabilistic model of expected user interactions and the one or more predetermined models developed from previously identified malicious user interaction scenarios in dependence on said feedback.

Receiving feedback related to output accuracy in response to reports and/or alerts can allow for the probabilistic model and/or neural network to adapt in response to feedback that the interaction is deemed to be correctly or incorrectly identified as abnormal and/or malicious, which can improve the accuracy of future outputs.

Optionally, metadata is extracted from one or more monitored computer networks via one or more of: an application programming interface, a stream from a file server, manual export, application proxy systems, active directory log-in systems, and/or physical data storage.

Using any of, combination of or all of an application programming interface, a stream from a file server, manual export, application proxy systems, active directory log-in systems, and/or physical data storage again allows for a variety of different types of metadata to be used.

Optionally, the method further comprises generating human-readable information relating to user interaction events. Optionally, said information is presented as part of a timeline.

Generating human-readable information, such as metadata, reports or log files, can improve the reporting of malicious behaviour and can allow for more efficient review of any outputs by administrators of a computer network or other personnel.

According to a second aspect, there is provided apparatus for identifying abnormal and/or malicious user interactions within one or more monitored computer networks, comprising: a metadata-ingesting module configured to receive and aggregate metadata from one or more devices within the one or more monitored computer networks; a data pipeline module configured to identify from the metadata events corresponding to a plurality of user interactions with the monitored computer networks; a data store configured to store user interaction event data from the identified said events corresponding to a plurality of user interactions with the monitored computer networks; and an analysis module comprising a probabilistic model of expected user interactions and an artificial neural network trained using one or more predetermined models developed from previously identified malicious user interaction scenarios, wherein the probabilistic model is updated from said stored user interaction event data; wherein the analysis module is used to test the user interaction events to identify abnormal and/or malicious user interactions.

According to an aspect, there is provided a method for identifying abnormal user interactions within one or more monitored computer networks, comprising the steps of: receiving metadata from one or more devices within the one or more monitored computer networks; identifying from the metadata events corresponding to a plurality of user interactions with the monitored computer networks; storing user interaction event data from the identified said events corresponding to a plurality of user interactions with the monitored computer networks; updating a probabilistic model of expected user interactions from said stored user interaction event data; and testing each of said plurality of user interactions with the monitored computer networks against said probabilistic model to identify abnormal user interactions.

The use of a probabilistic model allows existing users' actions to be compared against a model of their probable actions, which can be a dynamic model, enabling identification of malicious users of the monitored computer network or system. A large volume of input data can be used with the method and the model can be updated with user interactions to provide a dynamic model that is updated to generate a model of user interactions. The use of metadata related to user interactions (as encapsulated in log files, for example, which are typically already generated by devices and/or applications) means that a vast amount of data related to human interaction events can be obtained without needing to provide means to monitor the substantive content of user interactions with the system, which may be intrusive and difficult to set-up due to the volume of data that would then need to be processed. The term ‘metadata’ as used herein can be used to refer to log data and/or log metadata.

Optionally, the method further comprises testing each of the plurality of user interactions with the monitored computer networks against one or more predetermined models developed from previously identified malicious user interaction scenarios to identify malicious user interactions.

The use of predetermined models as well as the probabilistic model can provide a further way of detecting malicious users inside the monitored computer network, allowing threatening scenarios that may or may not otherwise be determined as particularly abnormal to be detected. Testing for both abnormal behaviour and identifiably malicious behaviour separately can improve the chances that security breaches can be detected.

Optionally, said user interaction event data comprises any or a combination of: data related to a user involved in an event; data related to an action performed in an event; and/or data related to a device and/or application involved in an event.

Organising data originating from metadata into a set of standardised database fields, for example into subject, verb, and object fields in a database, can allow data to be processed efficiently subsequently in terms of discrete events, and such a data structure can also allow associations to be made earlier between specific ‘subjects’ (such as users), ‘verbs’ (such as actions), and/or ‘objects’ (such as devices and/or applications), improving the usability of the data available.

Optionally, identifying from the metadata events corresponding to a plurality of user interactions with the monitored computer networks comprises extracting relevant parameters from computer and/or network device metadata and mapping said relevant parameters to a common data schema.

Mapping relevant parameters from metadata, for example log files, to or into a common data schema and format can make it possible for this normalised data to be compared more efficiently and/or faster.

Optionally, the method further comprises storing contextual data, wherein said contextual data is related to a user interaction event and/or any of: a user, an action, or an object involved in said event.

Contextual data, such as information about the user for example as job role and work/usage patterns, can be stored for later use to provide situational insights and assumptions that would not be apparent from the metadata, such as log files, alone. In particular, the contextual data stored can be that determined to be relevant by human and organisational psychology principles, which in turn may be used to explain or contextualise detected behaviours, which can assist to more accurately identify abnormal and/or malicious behaviour.

Optionally, identifying from the metadata events corresponding to a plurality of user interactions further comprises identifying additional parameters by reference to contextual data. Optionally, the contextual data comprises data related to any one or more of: identity data, job roles, psychological profiles, risk ratings, working or usage patterns, action permissibilities, and/or times and dates of events.

Contextual data such as identity data can be used to add additional parameters into data, which can enhance or increase the amount of data available about a particular event.

Optionally, the method further comprises testing each of the plurality of user interactions with the monitored computer networks against heuristics related to contextual data to identify abnormal and/or malicious user interactions.

The use of heuristics, for example predetermined heuristics based on psychological principles or insights, can allow for factors that may not be easily quantifiable to be taken into greater account, which can improve recognition of scenarios that may indicate malicious behaviour.

Optionally, a trained artificial neural network is used to test each of the plurality of user interactions with the monitored computer networks against the one or more predetermined models developed from previously identified malicious user interaction scenarios and the heuristics related to contextual data.

Artificial neural networks can be adaptive based on incoming data and can be pre-trained, or trained on an on-going basis, to recognise user behaviours that approximate predetermined or identified malicious scenarios.

Optionally, user interaction event data and contextual data are stored in a graph database.

The use of a graph database can allow for stored data to be updated and modified efficiently and can specifically allow for improved efficiency when storing or querying of relationships between events or other data.

Optionally, the method further comprises storing metadata and/or the relevant parameters therefrom in an index database.

Storing primary data such as the metadata, for example raw logs and/or extracted parameters, can be useful for auditing purposes and allowing checks to be made against any outputs.

Optionally, testing each of said plurality of user interactions with the monitored computer networks against said probabilistic model comprises performing continuous time analysis.

Performing analysis in continuous time (as opposed to discrete time) may allow for relative time differences between user interaction events to be more accurately computed.

Optionally, the method further comprises determining whether said two or more of the plurality of user interactions are part of an identifiable sequence of user interactions indicating user behaviour in performing an activity.

Identifying chains of user behaviour may assist in putting events in context, allowing for improved insights about user behaviour to be made.

Optionally, the method further comprises testing two or more of said plurality of user interactions in combination against said probabilistic model to identify abnormal user interactions.

Testing events in combination allows for single events to be set in the context of related events rather than just historic events. This may provide greater insight, such as by showing that apparently abnormal events are part of a local trend.

Optionally, the time difference between two or more of said plurality of user interactions is tested. Optionally, the time difference is tested against the time difference of related historic user interactions.

Testing the time difference may allow for events to be reliably assembled in their correct sequence. Additionally, distinctive time differences commonly detectable in certain types of event or situations for a particular user or device may be taken into account when testing for abnormality/maliciousness.

Optionally, receiving metadata comprises aggregating metadata at a single entry point.

The use of a single entry point to any system implementing the method minimises the potential for malicious users or third parties tampering with metadata such as log files and lowers latency associated with transmission of metadata, which can improve the time taken to process the metadata.

Optionally, metadata is received at the device via one or more of a third party server instance, a client server within one or more computer networks, or a direct link with the one or more devices.

Using any of, a combination of or all of a third party server instance, a client server within one or more computer networks, or a direct link with the one or more devices allows for a variety of different types of metadata to be used, while minimising time associated with metadata transmission.

Optionally, each of the plurality of user interactions with the monitored computer networks are tested for abnormality substantially immediately following said user interaction event data being stored.

Testing for abnormality as soon as possible can allow system breaches to be detected with minimal delay, which then allows for alerts to be issued to administrators of the system or for automated actions to be taken to curtail or stop the detected breach.

Optionally, each of the plurality of user interactions with the monitored computer networks are tested for abnormality according to a predetermined schedule in parallel with other tests. Optionally, testing for abnormality according to a predetermined schedule comprises analysing all available user interaction data corresponding to a plurality of user interactions with the monitored computer networks, wherein said plurality of user interactions occurred within a predetermined time period.

Scheduled processing ensures that metadata which is received some time after being generated can be processed in combination with metadata received in substantially real-time, or can be processed with the context of metadata received in substantially real-time, and can be processed taking into account the transmission and processing delay. Processing this later-received metadata can improve detection of malicious behaviour which may not be apparent from processing of solely the substantially real-time metadata.

Optionally, the method further comprises calculating a score for each of the plurality of user interactions and/or a plurality of user interactions in combination with the monitored computer networks based on one or more tests.

Calculating a score for each interaction and combinations of interactions can allow for the confidence with which user interactions are classified as abnormal and/or malicious to be assessed and/or relatively ranked.

Optionally, the method further comprises classifying each of the plurality of user interactions with the monitored computer networks based on a comparison of calculated scores for each of the plurality of user interactions and/or a plurality of user interactions in combination with one or more predetermined or dynamically calculated thresholds.

Classification based on thresholds allows for various classes of user interactions to be handled differently in further processing or reporting, improving processing efficiency as a whole and allowing prioritisation to occur.

Optionally, the method further comprises prioritising any identified abnormal and/or malicious user interactions using calculated scores and the potential impact of the identified abnormal and/or malicious user interactions.

Prioritising abnormal and/or malicious behaviour can allow generation of prioritised lists of identified abnormal or malicious user interactions for administrators of a system or network, such that resources within an organisation may be more effectively used to investigate the identified abnormal or malicious user interactions by reviewing the list of identified abnormal or malicious user interactions provided in priority order.

Optionally, the scores are calculated in additional dependence on one or more correlations between identified abnormal and/or malicious user interactions and one or more user interactions involving the user, action, and/or object involved in the identified abnormal and/or malicious user interactions.

Events can be compared with other events in an attempt to find relationships between events, which relationships may indicate a sequence of malicious events or malicious behaviour.

Optionally, the method further comprises reporting identified abnormal and/or malicious user interactions.

Reporting identified abnormal and/or malicious user interactions can be used to alert specific users or groups of users, for example network or system administrators, security personnel or management personnel, about interactions in substantially real-time or in condensed reports at regular intervals.

Optionally, the method further comprises implementing precautionary measures in response to one or more identified abnormal and/or malicious user interactions, said precautionary measures comprising one or more of: issuing an alert, issuing a block on a user or device or a session involving said user or device, saving data, and/or performing a custom programmable action.

The optional use of precautionary measures allows for automatic and immediate response to any immediately identifiable threats (such as system breaches), which may stop or at least hinder any breaches.

Optionally, the method further comprises receiving feedback related to the accuracy of the identification of the abnormal and/or malicious user interactions and updating the probabilistic model of expected user interactions and the one or more predetermined models developed from previously identified malicious user interaction scenarios in dependence on said feedback.

Receiving feedback related to output accuracy in response to reports and/or alerts can allow for the probabilistic model and/or neural network to adapt in response to feedback that the interaction is deemed to be correctly or incorrectly identified as abnormal and/or malicious, which can improve the accuracy of future outputs.

Optionally, metadata is extracted from one or more monitored computer networks via one or more of: an application programming interface, a stream from a file server, manual export, application proxy systems, active directory log-in systems, and/or physical data storage.

Using any of, combination of or all of an application programming interface, a stream from a file server, manual export, application proxy systems, active directory log-in systems, and/or physical data storage again allows for a variety of different types of metadata to be used.

Optionally, the method further comprises generating human-readable information relating to user interaction events. Optionally, said information is presented as part of a timeline.

Generating human-readable information, such as metadata, reports or log files, can improve the reporting of malicious behaviour and can allow for more efficient review of any outputs by administrators of a computer network or other personnel.

According to an aspect, there is provided apparatus for identifying abnormal and/or malicious user interactions within one or more monitored computer networks, comprising: a metadata-ingesting module configured to receive and aggregate metadata from one or more devices within the one or more monitored computer networks; a data pipeline module configured to identify from the metadata events corresponding to a plurality of user interactions with the monitored computer networks; a data store configured to store user interaction event data from the identified said events corresponding to a plurality of user interactions with the monitored computer networks; and an analysis module comprising a probabilistic model of expected user interactions and an artificial neural network trained using one or more predetermined models developed from previously identified malicious user interaction scenarios, wherein the probabilistic model is updated from said stored user interaction event data; wherein the analysis module is used to test the user interaction events to identify abnormal and/or malicious user interactions.

Apparatus can be provided that can be located within a computer network or system, or which can be provided in a distributed configuration between multiple related computer networks or systems in communication with one another, or alternatively can be provided at another location and in communication with the computer network or system to be monitored, for example in a data centre, virtual system, distributed system or cloud system.

Optionally, the apparatus further comprises a user interface accessible via a web portal and/or mobile application. Optionally, the user interface may be used to: view metrics, graphs and reports related to identified abnormal and/or malicious user interactions, query the data store, and/or provide feedback regarding identified abnormal and/or malicious user interactions.

Providing a user interface can allow for improved interaction with the operation of the apparatus by relevant personnel along with more efficient monitoring of any outputs from the apparatus.

Optionally, the apparatus further comprises a transfer module configured to aggregate and send at least a portion of the metadata from the one or more devices within the one or more monitored computer networks, wherein the transfer module is within the one or more monitored computer networks.

Providing a transfer module allows for many types of metadata (which are not already directly transmitted to the metadata-ingesting module) to be quickly and easily collated and transmitted to the metadata-ingesting module.

According to an aspect, there is provided a method for normalising metadata having a plurality of content schemata from one or more devices, within one or more monitored computer networks, comprising the steps of: receiving metadata from the one or more devices within the one or more monitored computer networks; extracting relevant parameters from the metadata and mapping said relevant parameters to a common data schema in order to identify events corresponding to a plurality of user interactions with the monitored computer networks; and storing user interaction event data from the identified said events corresponding to a plurality of user interactions with the monitored computer networks.

By mapping metadata parameters to a common data schema in order to identify events, the metadata from different sources may be pooled to provide a deeper and more comprehensive source of information, enabling use of the metadata for more effective and wide-reaching analysis. A large volume of input data can be used with the method. The use of metadata related to user interactions (as encapsulated in log files, for example, which are typically already generated by devices and/or applications) means that a vast amount of data related to human interaction events can be obtained without needing to provide means to monitor the substantive content of user interactions with the system, which may be intrusive and difficult to set-up due to the volume of data that would then need to be processed. Mapping relevant parameters from metadata, for example log files, to or into a common data schema and format can make it possible for this normalised data to be compared more efficiently and/or faster. The term ‘metadata’ as used herein can refer to log data and/or log metadata.

Optionally, said common data schema comprises: data identifying an action performed in an event; and data identifying a user involved in an event and/or data identifying a device and/or application involved in an event.

By providing interaction event data according to such a common data schema, automated generation of statements that are sensible and human-readable can be enabled. Organising data originating from metadata into a set of standardised database fields, for example into subject, verb, and object fields in a database, can allow data to be processed efficiently subsequently in terms of discrete events, and such a data structure can also allow associations to be made earlier between specific ‘subjects’ (such as users), ‘verbs’ (such as actions), and/or ‘objects’ (such as devices and/or applications), improving the usability of the data available.

Optionally, said common data schema further comprises any or a combination of: data related to the or a user involved in an event; data related to the or an action performed in an event; and/or data related to the or a device and/or application involved in an event.

By providing interaction event data according to such a common data, schema more detailed information can be provided and can enable flexibility as to the information that can be accommodated in the common data schemata.

Optionally, the mapping comprises looking up a metadata schema and allocating the extracted relevant parameters to the common data schema on the basis of the metadata schema.

By looking up a metadata schema, a wide variety of different metadata schemata can be accommodated. Thereby a great breadth of data sources and great flexibility can be enabled.

Optionally, the method further comprises identifying additional parameters related to the metadata. Optionally, the additional parameters are identified from a look-up table. Optionally, the method further comprises storing the additional parameters as part of the user interaction event data.

By identifying additional parameters and including them in the event data, more detailed information can be provided. By looking up additional parameters, a wide variety of different additional parameters can be accommodated.

Optionally, the method further comprises analysing the metadata. Optionally, the analysing comprises testing a first event against a second related event to identify a chain of related events. Optionally, the analysing comprises testing a first event against probabilistic model of a second related event to identify a chain of related events. Optionally, the method further comprises determining whether two or more of the plurality of user interactions are part of an identifiable sequence of user interactions.

Identifying chains of user behaviour may assist in putting events in context, allowing for improved insights about user behaviour to be made.

Optionally, the testing comprises performing continuous time analysis.

Performing analysis in continuous time (as opposed to discrete time) may allow for relative time differences between user interaction events to be more accurately computed.

Optionally, the method further comprises reporting.

Reporting can enable user access to the normalised metadata store.

Optionally, the reporting comprises compiling a sequence of one or more related events and providing data relating to those events. Optionally, the one or more related events relate to a particular time period. Optionally, reporting further comprising providing said data as part of a timeline. Optionally, the one or more related events relate to the same user, device, object, and/or chain.

By reporting a sequence of related events, a meaningful and easily understandable subset of information can be provided. A timeline can provide a particularly intuitive format.

Optionally, reporting comprises providing data relating to one or more events in the form of human-readable statements.

By providing human-readable statements, the information can be easily understandable. Generating human-readable information can improve the reporting and can allow for more efficient review of any outputs by administrators of a computer network or other personnel.

Optionally, receiving metadata comprises aggregating metadata at a single entry point.

The use of a single entry point to any system implementing the method minimises the potential for malicious users or third parties tampering with metadata such as log files and lowers latency associated with transmission of metadata, which can improve the time taken to process the metadata.

Optionally, metadata is received at the device via one or more of a third party server instance, a client server within one or more computer networks, or a direct link with the one or more devices.

Using any of, a combination of, or all of a third party server instance, a client server within one or more computer networks, or a direct link with the one or more devices allows for a variety of different types of metadata to be used, while minimising time associated with metadata transmission.

Optionally, metadata is extracted from one or more monitored computer networks via one or more of: an application programming interface, a stream from a file server, manual export, application proxy systems, active directory log-in systems, and/or physical data storage.

Using any of, a combination of or all of an application programming interface, a stream from a file server, manual export, application proxy systems, active directory log-in systems, and/or physical data storage again allows for a variety of different types of metadata to be used.

Optionally, user interaction event data and contextual data are stored in a graph database.

The use of a graph database can allow for stored data to be updated and modified efficiently and can specifically allow for improved efficiency when storing or querying of relationships between events or other data.

Optionally, the method further comprises storing metadata and/or the relevant parameters therefrom in an index database.

Storing primary data such as the metadata, for example raw logs and/or extracted parameters, can be useful for auditing purposes and allowing checks to be made against any outputs.

According to an aspect, there is provided apparatus for normalising metadata having a plurality of content schemata from one or more devices, within one or more monitored computer networks, comprising: a metadata-ingesting module configured to receive and aggregate metadata from one or more devices within the one or more monitored computer networks; a data pipeline module configured to extract relevant parameters from the metadata and map said relevant parameters to a common data schema in order to identify from the metadata events corresponding to a plurality of user interactions with the monitored computer networks; a data store configured to store user interaction event data from the identified said events corresponding to a plurality of user interactions with the monitored computer networks.

Apparatus can be provided that can be located within a computer network or system, or which can be provided in a distributed configuration between multiple related computer networks or systems in communication with one another, or alternatively can be provided at another location and in communication with the computer network or system to be monitored, for example in a data centre, virtual system, distributed system or cloud system.

Optionally, the apparatus further comprises a user interface accessible via a web portal and/or mobile application. Optionally, the user interface may be used to: view metrics, graphs and reports related to user interactions, such as identified abnormal and/or malicious user interactions, query the data store, and/or provide feedback regarding identified user interactions.

Providing a user interface can allow for improved interaction with the operation of the apparatus by relevant personnel along with more efficient monitoring of any outputs from the apparatus.

Optionally, the apparatus further comprises a transfer module configured to aggregate and send at least a portion of the metadata from the one or more devices within the one or more monitored computer networks, wherein the transfer module is within the one or more monitored computer networks.

Providing a transfer module allows for many types of metadata (which are not already directly transmitted to the metadata-ingesting module) to be quickly and easily collated and transmitted to the metadata-ingesting module.

Optionally, the data pipeline module is further configured to normalise the plurality of user interactions using a common data schema.

Providing a common data schema can make it possible for data to be compared more efficiently and/or faster.

These aspects extend to a computer program product comprising software code for carrying out any method as herein described.

These aspects extend to methods and/or apparatus substantially as herein described and/or as illustrated with reference to the accompanying drawings.

The invention extends to any novel aspects or features described and/or illustrated herein.

Any apparatus feature as described herein may also be provided as a method feature, and vice versa. As used herein, means plus function features may be expressed alternatively in terms of their corresponding structure, such as a suitably programmed processor and associated memory.

Any feature in one aspect may be applied to other aspects, in any appropriate combination. In particular, method aspects may be applied to apparatus aspects, and vice versa. Furthermore, any, some and/or all features in one aspect can be applied to any, some and/or all features in any other aspect, in any appropriate combination.

It should also be appreciated that particular combinations of the various features described and defined in any aspects can be implemented and/or supplied and/or used independently.

The term ‘server’ as used herein should be taken to include local physical servers and public or private cloud servers, or applications running server instances.

The term ‘event’ as used herein should be taken to mean a discrete and detectable user interaction with a system.

The term ‘user’ as used herein should be taken to mean a human interacting with various devices and/or applications within or interacting with a client system, rather than the user of the log processing system, which is denoted herein by the term ‘operator’.

The term ‘behaviour’ as used herein may be taken to refer to a series of events performed by a user.

### BRIEF DESCRIPTION OF THE DRAWINGS

Embodiments will now be described, by way of example only and with reference to the accompanying drawings having like-reference numerals, in which:

FIG. 1 shows a schematic illustration of the structure of a network including a security system;

FIG. 2 shows a schematic illustration of log file aggregation in the network of FIG. 1;

FIG. 3 shows a flow chart illustrating the log normalisation process;

FIG. 4 shows a schematic diagram of data flows in the security provision system;

FIG. 5 shows a flow chart illustrating the operation of an analysis engine in the log processing system;

FIG. 6 shows an exemplary report produced by the log processing system; and

FIG. 7 shows a further exemplary report produced by the log processing system.

### SPECIFIC DESCRIPTION

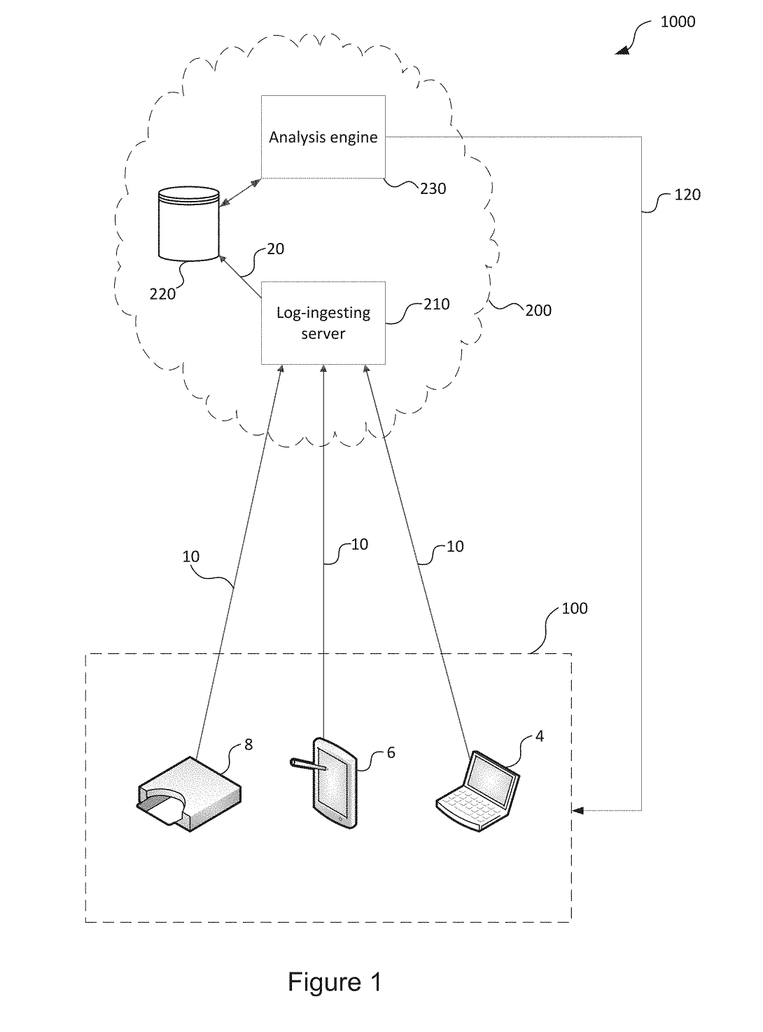

FIG. 1 shows a schematic illustration of the structure of a network 1000 including an information processing system according to an embodiment.

The network 1000 comprises a client system 100 and a log processing system 200. The client system 100 is a corporate IT system or network, in which there is communication with and between a variety of user devices 4, 6, such as one or more laptop computer devices 4 and one or more mobile devices 6. These devices 4, 6 may be configured to use a variety of software applications which may, for example, include communication systems, applications, web browsers, and word processors, among many other examples.

Other devices (not shown) that may be present on the client system 100 can include servers, data storage systems, communication devices such as ‘phones and videoconference and desktop workstations among other devices capable of communicating via a network.

The network may include any of a wired network or wireless network infrastructure, including Ethernet-based computer networking protocols and wireless 802.11x or Bluetooth computer networking protocols, among others.

Other types of computer network or system can be used in other embodiments, including but not limited to mesh networks or mobile data networks or virtual and/or distributed networks provided across different physical networks.

The client system 100 can also include networked physical authentication devices, such as one or more key card or RFID door locks 8, and may include other “smart” devices such as electronic windows, centrally managed central heating systems, biometric authentication systems, or other sensors which measure changes in the physical environment.

All devices 4, 6, 8 and applications hosted upon the devices 4, 6, 8 will be referred to generically as “data sources” for the purposes of this description.

As users interact with the client system 100 using one or more devices 4, 6, 8, metadata relating to these interactions will be generated by the devices 4, 6, 8 and by any network infrastructure used by those devices 4, 6, 8, for example any servers and network switches. The metadata generated by these interactions will differ depending on the application and which the device 4, 6, 8 is used.

For example, where a user places a telephone call using a device 8, the generated metadata may include information such as the phone numbers of the parties to the call, the serial numbers of the device or devices used, and the time and duration of the call, among other possible types of information such as bandwidth of the call data and, if the call is a voice over internet call, the points in the network through which the call data was routed as well as the ultimate destination for the call data. Metadata is typically saved in a log file 10 that is unique to the device and the application, providing a record of user interactions. The log file 10 may be saved to local memory on the device 8 or a local or cloud server, or pushed or pulled to a local or cloud server, or both. If for example, the telephone call uses the network to place a voice over internet call, log files 10 will also be saved by the network infrastructure used to connect the users to establish a call as well as any data required to make the call that was requested from or transmitted to a server, for example a server providing billing services, address book functions or network address lookup services for other users of a voice over internet service.

In the network 1000, the log files 10 are exported to the log processing system 200. It will be appreciated that the log files 10 may be exported via an intermediary entity (which may be within or outside the client system 100) rather than being exported directly from devices 4, 6, 8, as shown in the Figure.

The log processing system 200 comprises a log-ingesting server 210, a data store 220 (which may comprise a number of databases with different properties so as to better suit various types of data, such as an index database 222 and a graph database 224, for example), and an analysis engine 230.

The log-ingesting server 210 acts to aggregate received log files 10, which originate from the client system 100 and typically the log files 10 will originate from the variety of devices 4, 6, 8 within the client system 100 and so can have a wide variety of formats and parameters. The log-ingesting server 210 then exports the received log files 10 to the data store 220, where they are processed into normalised log files 20. The analysis engine 230 evaluates the normalised log files 20.

In an example, the log processing system 200 may be used for security provision. The log processing system 200 may in such cases be referred to as a security provision system 200. In security processing, the analysis engine 230 compares the normalised log files 20 (providing a measure of present user interactions) to data previously saved in the data store (providing a measure of historic user interactions) and evaluates whether the normalised log files 20 show or indicate that the present user interactions are normal or abnormal. Additionally, the detected interactions may be tested against various predetermined or trained scenarios in an attempt to detect identifiably malicious behaviour. Reports 120 of abnormal and/or malicious activity may then be reported back to the client system 100, to a specific user or group of users or as a report document saved on a server or document share on the client system 100. The log processing system 200, using the above process, determines whether users are considered to be behaving abnormally, and also determines whether users are considered to be acting maliciously by this abnormal behaviour. Once abnormal behaviour (which may be suspicious) has been identified it may subsequently be categorised as malicious.

It will be appreciated that the log processing system 200 does not require the substantive content, i.e. the raw data generated by the user, of a user's interaction with a system as an input. Instead, the log processing system 200 uses only metadata relating to the user's interactions, which is typically already gathered by devices 4, 6, 8 on the client system 100. This approach may have the benefit of helping to assuage or prevent any confidentiality and user privacy concerns.

The log processing system 200 operates independently from the client system 100, and, as long as it is able to normalise each log file 10 received from a device 4, 6, 8 on the client system 100, the log processing system 200 may be used with many client systems 100 with relatively little bespoke configuration. The log processing system 200 can be cloud-based, providing for greater flexibility and improved resource usage and scalability.

The log processing system 200 can be used in a way that is not network intrusive, and does not require physical installation into a local area network or into network adapters. This is advantageous for both security and for ease of set-up, but requires that log files 10 are imported into the system 200 either manually or exported from the client system 100 in real-time or near real-time or in batches at certain time intervals.

Examples of metadata, logging metadata, or log files 10 (these terms can be used interchangeably), include security audit logs created as standard by cloud hosting or infrastructure providers for compliance and forensic monitoring providers. Similar logging metadata or log files are created by many standard on-premises systems, such as SharePoint, Microsoft Exchange, and many security information and event management (SIEM) services. File system logs recording discrete events, such as logons or operations on files, may also be used and these file system logs may be accessible from physically maintained servers or directory services, such as those using Windows Active Directory. Log files 10 may also comprise logs of discrete activities for some applications, such as email clients, gateways or servers, which may, for example, supply information about the identity of the sender of an email and the time at which the email was sent, along with other properties of the email (such as the presence of any attachments and data size). Logs compiled by machine operating systems may also be used, such as Windows event logs, for example as found on desktop computers and laptop computers. Non-standard log files 10, for example those assembled by ‘smart’ devices (as part of an “internet of things” infrastructure, for example) may also be used, typically by collecting them from the platform to which they are synchronised (which may be a cloud platform) rather than, or as well as, direct collection from the device. It will be appreciated that a variety of other kinds of logs can be used in the log processing system 200.

The log files 10 listed above typically comprise data in a structured format, such as extensible mark-up language (XML), JavaScript object notation (JSON), or comma-separated values (CSV), but may also comprise data in an unstructured format, such as the syslog format for example. Unstructured data may require additional processing, such as natural language processing, in order to define a schema to allow further processing.

The log files 10 may comprise data related to a user (such as an identifier or a name), the associated device or application, a location, an IP address, an event type, parameters related to an event, time, and/or duration. It will, however, be appreciated that log files 10 may vary substantially and so may comprise substantially different data between types of log file 10.

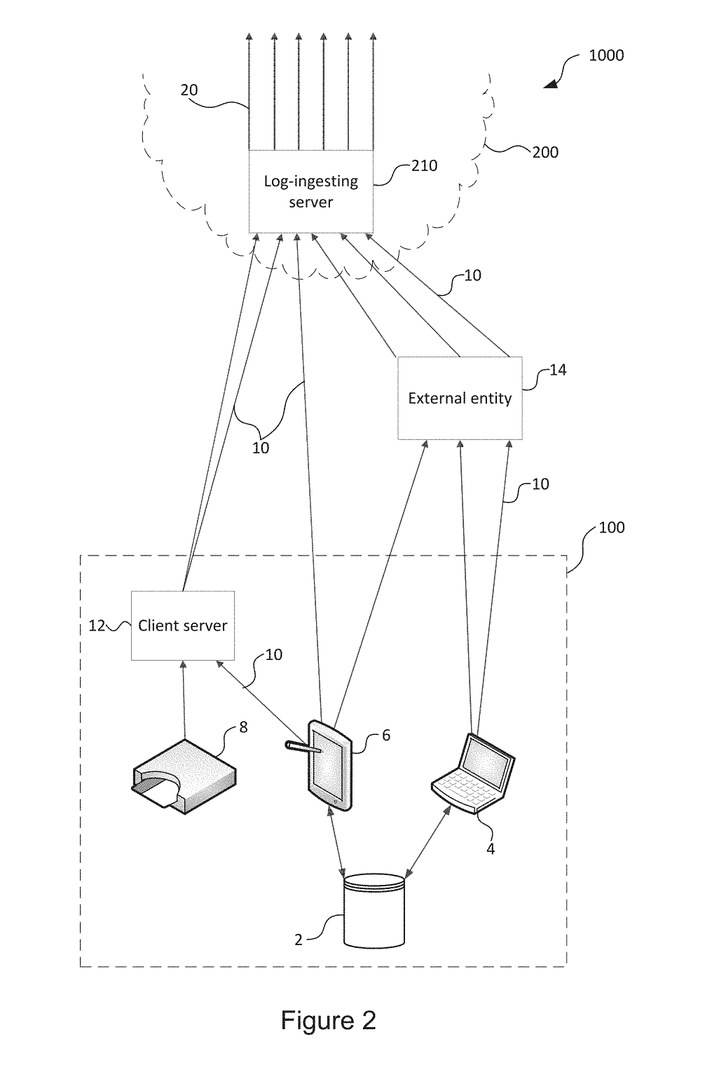

FIG. 2 shows a schematic illustration of log file 10 aggregation in the network 1000 of FIG. 1. As shown in FIG. 2, multiple log files 10 are taken from single devices 4, 6, 8, because each user may use a plurality of applications on each device, thus generating multiple log files 10 per device.

Some devices 4, 6 may also access a data store 2 (which may store secure data, for example), in some embodiments, so log files 10 can be acquired from the data store 2 by the log processing system 200 directly or via another device 4, 6.

If the log files 10 used are transmitted to the log-ingesting server as close to the time that they are created as possible, this can minimise latency and improve the responsiveness of the log processing system 200. This also serves to reduce the potential for any tampering with the log files 10 by malicious third parties, for example to excise log data relating to an unauthorised action within the client system 100 from any log files 10. For some devices, applications or services, a ‘live’ transmission can be configured to continuously transmit one or more data streams of log data to the log processing system 200 as data is generated. Technical constraints, however, may necessitate that exports of log data occur only at set intervals for some or all devices or applications, transferring batches of log data or log files for the intervening interval since the last log data or log file was transmitted to the log processing system 200.

Log data 10 may be transmitted by one or more means (which will be described later on) from a central client server 12 which receives log data 10 from various devices. This may avoid the effort and impracticality of installing client software on every single device. Alternatively, client software may be installed on individual workstations if needed. Client systems 100 may comprise SIEM (security information and event management) systems which gather logs from devices and end-user laptops/phones/tablets, etc.

For some devices such as key cards 8 and sensors, the data may be made available by the data sources themselves, as well as by the relevant client servers 12 (e.g. telephony server, card access server) that collect data.

In some cases, one or more log files 10 may be transmitted to or generated by an external entity 14 (such as a third party server) prior to transmission to the log processing system 200. This external entity 14 may be, for example, a cloud hosting provider, such as SharePoint Online, Office 365, Dropbox, or Google Drive, or a cloud infrastructure provider such as Amazon AWS, Google App Engine, or Azure.

Log files 10 may be transmitted from a client server 12, external entity 14, or device 4, 6, 8 to the log-ingesting server 210 by a variety of means and routes including:
1. an application programming interface (API) for example arranged to push log data to the log-ingesting server 210, or arranged such that log data can be pulled to the log-ingesting server 210, at regular intervals or in response to new log data. Log data 10 may be collected automatically in real time or near-real time as long as the appropriate permissions are in place to allow transfer of this log metadata 10 from the client network 100 to the log processing system 200. These permissions may, for example, be based on the OAuth standard. Log files 10 may be transmitted to the log-ingesting server 210 directly from a device 4, 6, 8 using a variety of communication protocols. This is typically not possible for sources of log files 10 such as on-premises systems and/or physical sources, which require alternative solutions.
2. file server streams where a physical file is being created. A software-based transfer agent installed inside the client system 100 may be used in this regard. This transfer agent may be used to aggregate log data 10 from many different sources within the client network 100 and securely stream or export the log files 10 or log data 10 to the log-ingesting server 210. This process may involve storing the collected log files 10 and/or log data 10 into one or more log files 10 at regular intervals, whereupon the one or more log files 10 is transmitted to the log processing system 200. The use of a transfer agent can allow for quasi-live transmission, with a delay of approximately 1 ms-30 s, or any latency inherently present in generated data or the network.
3. manual export by an administrator or individual users via a transfer agent.
4. intermediary systems (e.g. application proxy, active directory login systems, or SIEM systems)
5. physical data storage means such as a thumb drive or hard disk or optical disk can be used to transfer data in some cases, for example, where data might be too big to send over slow network connections (e.g. a large volume of historical data).

The log files 10 enter the system via the log-ingesting server 210. The log-ingesting server 210 aggregates all relevant log files 10 at a single point and forwards them on to be transformed into normalised log files 20. This central aggregation (with devices 4, 6, 8 independently interacting with the log-ingesting server 210) reduces the potential for log data being modified by an unauthorised user or changed to remove, add or amend metadata, and preserves the potential for later integrity checks to be made against raw log files 10.

A normalisation process is then used to transform the log files 10 (which may be in various different formats) into generic normalised metadata or log files 20. The normalisation process operates by modelling any human interaction with the client system 100 by breaking it down into discrete events. These events are identified from the content of the log files 10. A schema for each data source used in the network 1000 is defined so that any log file 10 from a known data source in the network 1000 has an identifiable structure, and ‘events’ and other associated parameters (which may, for example, be metadata related to the events) may be easily identified and be transposed into the schema for the normalised log files 20.

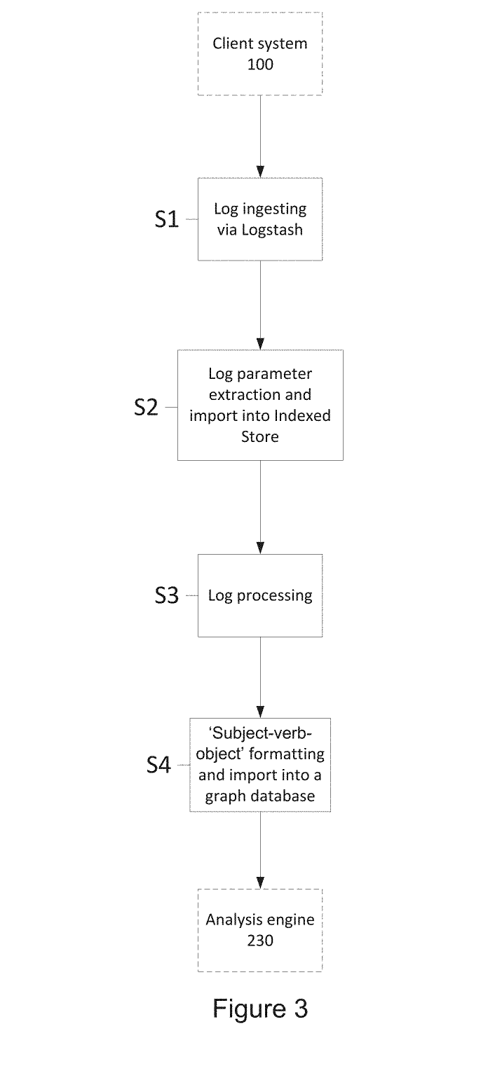

FIG. 3 shows a flow chart illustrating the log normalisation process in a log processing system 200. The operation may be described as follows (with an accompanying example):

Stage 1 (S1). Log files 10 are received at the log-ingesting server 210 from the client system 100 and are parsed using centralised logging software, such as the Elasticsearch BV “Logstash” software. The centralised logging software can process the log files from multiple hosts/sources to a single destination file storage area in what is termed a “pipeline” process. A pipeline process provides for an efficient, low latency and flexible normalisation process.

An example line of a log file 10 that might be used in the log processing system 200 and parsed at this stage (S1) may be similar to the following:

L,08/08/12:14:36:02,00D70000000IiIT,00570000001IJJB,204.14.239.208,/,,,,“Mozilla/5.0 (Windows NT 6.1; WOW64) AppleWebKit/536.11 (KHTML, like Gecko) Chrome/20.0.1132.57 Safari/536.11”,,,,,,,,

The above example is a line from a log file 10 created by the well-known Salesforce platform, in Salesforce's bespoke event log file format. This example metadata extract records a user authentication, or “log in” event.

Stage 2 (S2). Parameters may then be extracted from the log files 10 using the known schema for the log data from each data source. Regular expressions or the centralised logging software may be used to extract the parameters, although it will be appreciated that a variety of methods may be used to extract parameters. The extracted parameters may then be saved in the index database 222 prior to further processing. Alternatively, or additionally, the parsed log files 10 may also be archived at this stage into the data store 220. In the example shown, the following parameters may be extracted (the precise format shown is merely exemplary):

```
{
      “logRecordType”: “Login”,
      “DateTime”: “08/08/12:14:36:02”,
      “organizationId”: “00D70000000lilT”,
      “userId”: “00570000001IJJB”,
      “IP”: “10.228.68.70”,
      “URI”: “/”,
      “URI Info”: “”,
      “Search Query”: “”,
      “entities”: “”,
      “browserType”: “Mozilla/5.0 (Windows NT 6.1; WOW64)
      AppleWebKit/536.11 (KHTML: like Gecko) Chrome/20.0.1132.57
      Safari/536.11”,
      “clientName”: “”,
      “requestMethod”: “”,
      “methodName”: “”,
      “Dashboard Running User”: “”,
      “msg”: “”,
      “entityName”: “”,
      “rowsProcessed”: “”,
      “Exported Report Metadata”: “”
}
```

Stage 3 (S3). The system 200 may then look up additional data 40 in the data store 220, which may be associated with the user or IDs in the data above, for example, and use the additional data to add new parameters where possible and/or expand or enhance the existing parameters. The new set of parameters or enhanced parameters may then be saved in the index database 222. The additional data 40 may be initialised by a one-time setup for a particular client system 100. The additional data 40 might be also or alternatively be updated directly from directory services such as Windows Active Directory. When new additional data 40 becomes available, previous records can be updated as well with the new additional data 40. The additional data 40 can enable, for example, recognition of two users from two different systems as actually being the same user (“johndoe” on SalesForce is actually “jd” on the local network and “jdoe01@domain.tld” on a separate email system).The same principle applies at a file basis, rather than a user basis: additional data 40 can enable recognition of two data files from different systems as actually being the same file (“summary.docx” on the local server is the same document as “ForBob.docx” on Dropbox).

In the example previously described, the newly processed parameters may be shown as (with new data in bold):

```
{
      “logRecordType”: “Login”,
      “DateTime”: “08/08/12:14:36:02”,
      “organizationId”: “ACME Corp Ltd”,
      “userId”: “jdoe12”,
      “userFirstName”: “Jonathan”,
      “userLastName”: “Doe”,
      “IP”: “204.14.239.208”,
      “location”: {
            “country”: “US”,
            “state”: “CA”,
            “city”: “San Francisco”
      },
      “URI”: “/”,
      “URI Info”: “”,
      “Search Query”: “”,
        “entities”: “”,
      “browserType”:  “Mozilla/5.0  (Windows  NT  6.1;
      WOW64) AppleWebKit/536.11  (KHTML:  like  Gecko)
      Chrome/20.0.1132.57 Safari/536.11”,
      “browser”: “Chrome 20”,
      “OS”: “Windows 7”,
      “clientName”: “”,
      “requestMethod”: “”,
      “methodName”: “”,
      “Dashboard Running User”: “”,
      “msg”: “”,
      “entityName”: “”,
      “rowsProcessed”: “”,
      “Exported Report Metadata”: “”
}
```

Stage 4 (S4). To improve later analysis of user interaction with the client system 100 it is necessary to clearly identify events in ‘subject-verb-object’ format, rather than using a set of parameters related to an event as produced by steps S1-S3. At this processing stage the system 200 acts to identify ‘subject-verb-object’ combinations from the processed log data—where a ‘subject’ may comprise data relating to a user and related attributes, a ‘verb’ comprises data related to a particular action or activity together with related attributes, and an ‘object’ comprises data related to a target entity (such as a device or application) together with related attributes.

Arranging relevant data from the example event in a normalised ‘subject-verb-object’ format might take the following form (shown in a table):

| | | |
|---|---|---|
| Subject | Verb | Object |
| jdoe12 | login | Salesforce |

| | | |
|---|---|---|
| time | | 8th August |
| | | 12:14:36.02 |
| userFirstName | Jonathan | |
| userLastName | Doe | |
| organisation | Acme Corp Ltd | |
| location | US/CA/San | |
| | Francisco | |
| browser | Chrome 20 | |
| OS | Windows 7 | |

In another example, a log may specify: TeamX AdministratorY removed UserZ from GroupT. This can convert into multiple “sentences”: “AdministratorY removed (from GroupT) UserZ” or “UserZ was removed (by AdministratorY) from GroupT”. These statements convey the same information but with various subjects. Typically the schema for ‘subject-verb-object’ combinations is configured on a per log type basis, but a certain degree of automation is possible. Industry standard fields like emails, userid, active directory, date/time etc. can be automatically recognised due to applications following norms and international standards. Implicitly, this means that a class of data sources can potentially have the same schema type and could be handled by simply defining a class schema (e.g. a ‘security information event management’ class schema).

The normalised data can then be formatted in a normalised log file 20 and saved in the graph database 224. The graph database 224 allows efficient queries to be performed on the relationships between data and allows for stored data to be updated, tagged or otherwise modified in a straightforward manner. The index database 222 may act primarily as a static data store in this case, with the graph database 224 able to request data from the index database 222 and use it to update or enhance the “graph” data in response to queries from the analysis engine 230. The ‘subject-verb-object’ format is represented in a graph database by two nodes (‘subject’ e.g. ‘AdministratorY’ and ‘object’ e.g. ‘UserZ’) with a connection (‘verb’ e.g. ‘remove’). Parameters are then added to all three entities (e.g. the “remove” action has parameters group and time).

Examples of index databases 22 that may be used include “mongoDB”, “elastic”, but also time series databases like InfluxDB, Druid and TSDB; an example of a graph database 224 that could be used is “neo4j”.

The databases making up the data store 220 can be non-SQL databases, which tend to be more flexible and easily scalable. It will be appreciated that the use of data related to log files from many distributed sources across a long time period means that the log processing system 200 may store and process a very high volume of data.

The normalised log files 20 have a generic schema that may comprise a variety of parameters, which can be nested in the schema. The schema is optionally graph-based. The parameters included will vary to some extent based on the device and/or application that the log files 10 originate from, but the core ‘subject-verb-object’-related parameters are consistent across normalised log files 20 in typical configurations. Providing a unified generic schema for the normalised log files 20 enables the same schema to be adapted to any source of metadata, including new data sources or new data formats, and allows it to be scaled up to include complex information parameters. The generic schema can be used for ‘incomplete’ data by setting fields as ‘null’. Optionally, these null fields may then be found by reference to additional data 40 or data related to other events. Additionally, the use of a generic schema for the normalised log files 20 and a definition of a schema for the log files originating from a particular data source means that the log processing system 200 may be said to be system-agnostic, in that, as long as the client system 100 comprises devices 4, 6, 8 which produce log files 10 with a pre-identified schema, the log processing system 200 can be used with many client systems 100 without further configuration.

It is important that the normalised log files 20 are synchronised as accurately as possible in order for each user interaction with different components/devices/services of the client system 100 to be compared, for example with the benefit of accurate representations of sequences of events. For many applications of the log processing system 200, analysis of small time gaps between events may be an important factor in identifying abnormal user behaviour. All log files 10 used by the log processing system 200 should therefore contain timestamp information, allowing the log files 10 to be placed in their proper relative context even when the delays between file generation and receipt at the log-ingesting server 220 differ. The log files 10 may, optionally, be time stamped/re-time stamped at the point of aggregation or at the point at which the normalisation processing occurs in order to compensate for errors in time stamping, for example.

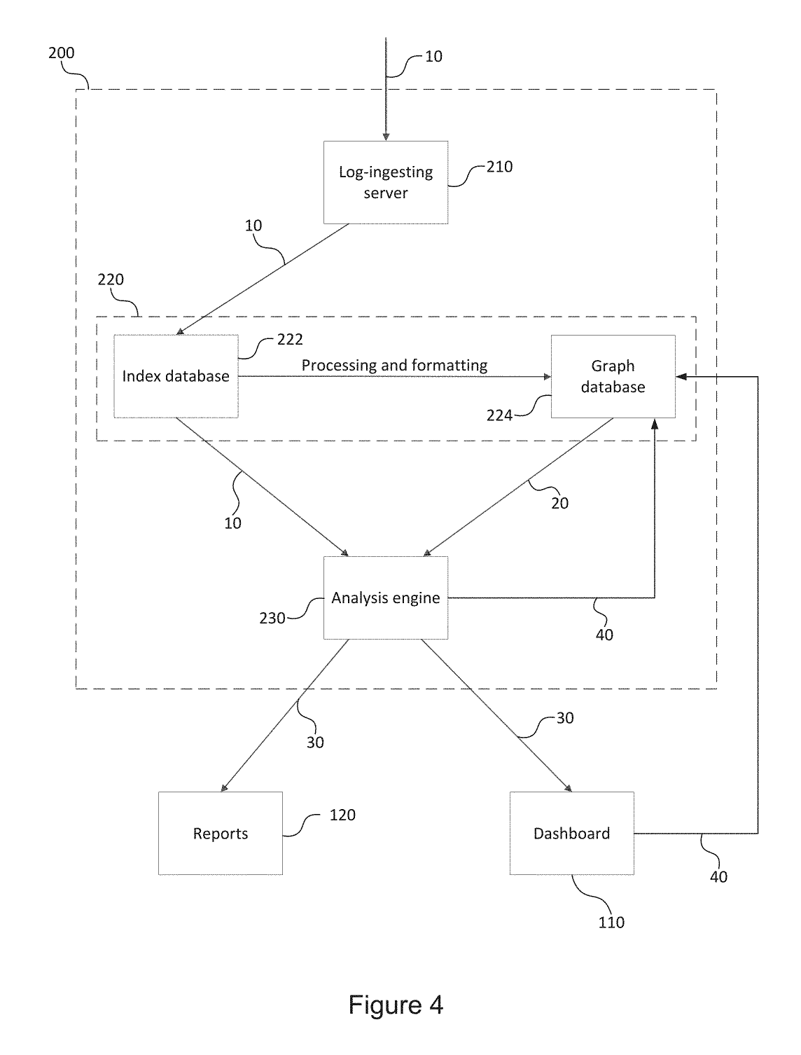

FIG. 4 shows a schematic diagram of data flows in the log processing system 200. As shown, the analysis engine 230 may receive data (as normalised log files 20) from both the graph database 224 and, optionally, the index database 222, and may produce outputs 30 which may be presented to an administrator via reports 120 or on a ‘dashboard’ web portal or application 110. Outputs 30 may comprise an event or series of events or a group of events. The analysis engine 230 may perform a specific analysis on the log data. For example analysis may be directed to identifying behaviour based on the log data, but other analysis is possible with the log data. Alternatively the data from the normalised log files may simply be provided, in bulk or a subset, on demand or as a feed.

Outputs 30 may be classified based on one or more thresholds—so that an output 30 may be classified as ‘abnormal’, ‘abnormal and potentially malicious’, or ‘abnormal and identifiably malicious’, for example. This will be described later on with reference to reports 120 produced by the system. The thresholds used may be absolute thresholds, which are predetermined (by an operator, for example), or relative thresholds, which may relate to a percentage or standard deviation and so require that an exact value for the threshold is calculated on a per-event output 30 basis.

Additional contextual data and/or feedback 40 may be entered by an administrator (or other authorised) user using the dashboard 110 (which will be described later). This contextual data 40 is stored in the data store 220, optionally with the relevant data directly related to events. This contextual data 40 may be generated and saved by the analysis engine 230, as will be described later on, or may be manually input into the data store 220 by an administrator of the client system 100, for example. This contextual data 40 may be associated with a given user, device, application or activity, producing a ‘profile’ which is saved in the data store 220. The contextual data 40 may be based on cues that are largely or wholly non-quantitative, being based on human and organisational psychology. The use of this data 40 allows for complex human factors to be taken into account when assessing a user's behaviour, rather than relying on the event-by-event account supplied by collected log files 10. Contextual data 40 related to a user may comprise, for example, job role, working patterns, personality type, and risk rating (for example, a user who is an administrator may have a higher level of permissions within a client system 100, and so represent a high risk). Other contextual data 40 may include the sensitivity of a document or a set of documents, the typical usage patterns of a workstation or user, or the permissibility of a given application or activity by that user. Many other different factors can be included in this contextual data 40, some of which will be described later on with reference to example malicious activities. The contextual data 40 is used for risk analysis, for distinction between malicious behaviour/abnormal behaviour, and for alert generation. The contextual data 40 includes psychology-related data that is integrated into the log processing system 200 by modelling qualitative studies into chains of possible events/intentions with various probabilities based on parameters like age, gender, cultural background, role in the organisation, and personality type.

In another example of analysis chains of events are identified. This includes for example events that are undertaken in sequence by the same user and relating to the same piece of work. In an example, one chain includes opening an email programme, saving a document, and sending an email with the document attached. In parallel a second chain includes opening a web browser, logging onto a literature database, and downloading 4 documents to a handheld device. The analysis engine can recognise events as part of a chain by performing probability calculations to determine the probability of two events occurring one after another. In order to strengthen the analysis the analysis engine can use continuous and discrete time to determine the probability of these events occurring at time X distance from one another. The user can multitask, so multiple chains can run simultaneously. Multitasking behaviour can be identified based on parameters (e.g. using two different browsers) or accessing unrelated services (e.g. logging onto Salesforce; and placing an internal phone call).

Analysis based on continuous time (as opposed to discrete time) may be used to analyse probabilities with more accuracy. Continuous time may allow for millisecond/nanosecond differences between actions to be detected. For analysing sequences of events, the relative timing between actions (and not necessarily exact time of day) is important. By analysing the timeline of a sequence of events separated by small amounts of time, chains of actions (corresponding to complex behaviour) can be resolved. Because time is a continuous variable in the continuous time approach, the way questions are asked changes, as follows:
in discrete time, the analysis engine 230 would be able to compute the probability of a user performing an action in a time interval. The probability of this action being performed by the user is equal throughout that slot.
in continuous time, the analysis engine 230 may compute much more precisely exact values for different times, such as one millisecond apart.

In order to calculate values and/or analyse probabilities in continuous time, an appropriate model may use differential equations, interpolation and/or other continuous approximation functions.

The analysis engine 230 may comprise a plurality of algorithms packaged as individual modules. The modules are developed according to machine learning principles which are specialized in modelling a single or a subset of behavioural traits. The modules may be arranged to operate and/or learn on all data sources provided by the normalised log data, or a subset of the data sources. The analysis engine 230 may be arranged to extract certain parameters provided in the normalised log data and provide the parameters to the modules.

The individual modules can be any unsupervised or supervised algorithms, and may use one or more of a plurality of algorithms. The algorithms may incorporate one or more static rules, which may be defined by operator feedback. The algorithms may be based on any combination of simple statistical rules (such as medians, averages, and moving averages), density estimation methods (such as Gaussian mixture models, kernel density estimation), clustering based methods (such as density based, partitioning based, or statistical model based clustering methods, Bayesian clustering, or K-means clustering algorithms), and graph-based methods being arranged to detect social patterns (which may be referred to as social graph analysis), resource access activity, and/or resource importance and relevance (which may be referred to as collaborative filtering). The graph-based methods can be clustered and/or modelled over time. In addition, time series anomaly detection techniques may be used, such as change point statistics or WSARE algorithms (also known as “what's strange about recent events” algorithms). Although the algorithms may be unsupervised, they may be used in combination with supervised models such as neural networks. The supervised neural network may be trained to recognise patterns of events (based on examples, or feedback by the operator) which may indicate that the user is unexpectedly changing their behaviour or marks a long term in their normal behaviour (the saved data relating to a user's normal behaviour may then be updated accordingly). The algorithms as a whole may therefore be referred to as ‘supervised-unsupervised’.

Additionally, the analysis engine 230 comprises a higher layer probabilistic model providing a second layer of statistical learning, which is arranged to combine the outcomes of the individual modules and detect changes at a higher, more abstract, level. This may be used to identify abnormal and/or malicious human interactions with the client system 100. The second layer of statistical learning may be provided by clustering users based on the data produced by the individual modules. Changes in the clusters may be detected, and/or associations can be made between clusters. The change in the data produced by the individual modules may be modelled over time. The data produced by the individual modules may also be dynamically weighted, and/or the data produced by the individual modules may be predicted.

Optionally, the analysis engine 230 may be arranged to pre-process data to be used as an input for the modules. The pre-processing may comprise any of: aggregating or selecting data based on a location associated with the normalised log data or a time at which the data is received and/or generated, determining parameters (such as a ratio of two parameters provided as part of the normalised log data), performing time series modelling on certain parameters provided in the normalised log data (for example, using continuous models such as autoregressive integrated moving average (ARIMA) models and/or discrete models such as string-based action sequences). The pre-processing may be based on the output of one of more of the modules related to a particular parameter, how the output changes over time and/or historic data related to the output.

One of the main problems with machine learning systems is a paucity of data for training purposes; however, the high volume of data collected and saved by the log processing system 200 means development of an effective algorithm for the analysis engine 230 is possible. If not enough data is available, for example, in the case where new employees (which have a high associated degree of risk) join a business, we can use data from employees similar to them based on role, department, behaviour, etc. as well as based on the pre-modelled psychological traits.

The analysis engine 230 is able to detect user interaction with the client system 100 (via device log files 10) by comparing current data against historic data, but not all abnormal behaviour is necessarily malicious. The analysis engine 230 may therefore be trained (by being shown examples) to detect human interaction with the system indicating that malicious activity is occurring rather than simply abnormal behaviour. Examples of such interaction might include, in a simple example, a user downloading many documents that they had never previously accessed—this interaction can be either abnormal or abnormal and malicious.

Many indications that a user is acting maliciously may be cues that are largely or wholly non-quantitative, being based on human and organisational psychology. In addition to using contextual data 40, examples based on these cues may be fed into the analysis engine 230, allowing the analysis engine 230 to take these cues into account when evaluating whether a user's behaviour is suspicious, even if there are no ‘obvious’ signs (in terms of the data that the user accesses, for example) that malicious activity is taking place. In an example, all employees of type ‘technician’ may go on a day trip (while rest of the company works as normal) and thus display negligible system activity. If in that situation one or more technicians show elevated activity that would go against business/team principles, this may be flagged/identified, compared to their behaviour patterns, and reported.

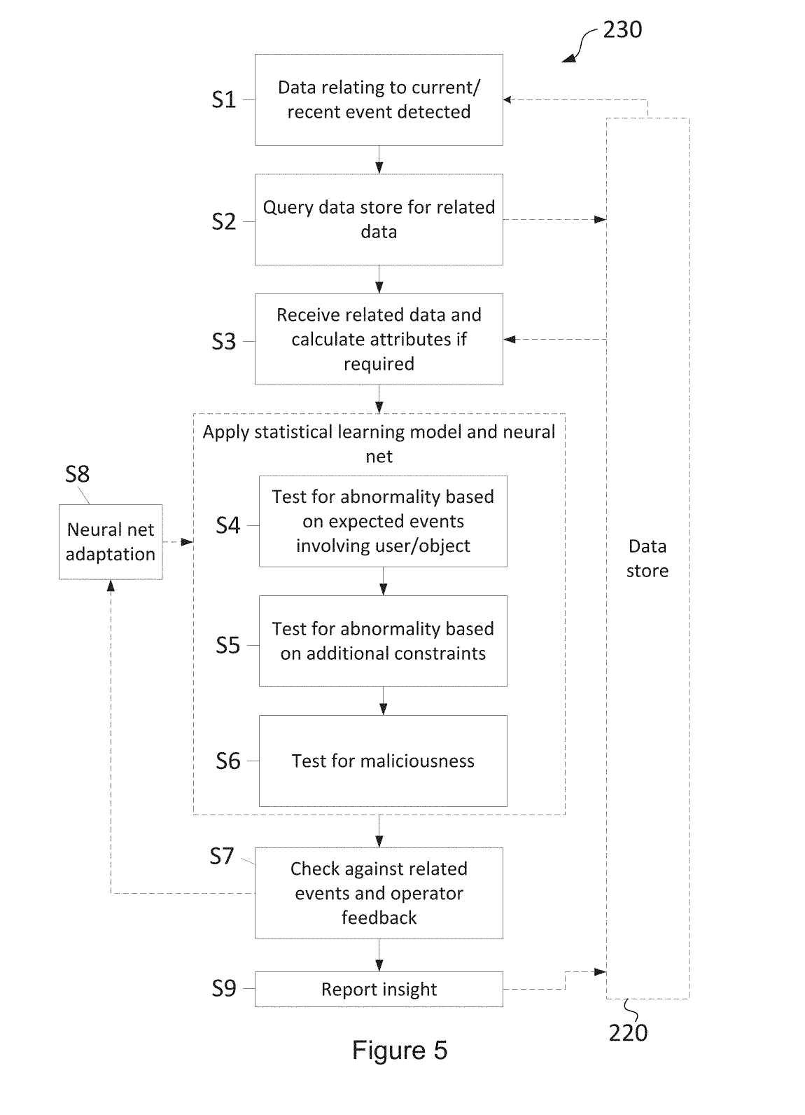

FIG. 5 shows a flow chart illustrating the operation of the analysis engine 230 in the log processing system 200, where the analysis engine 230 is configured to operate to detect abnormal and malicious behaviour. The operation may be described as follows:

Stage 1 (S1). The analysis engine 230 detects that information related to an event is available via the data store 220. This information may comprise normalised log files 20 which have been normalised and pushed into the data store 220 immediately before being detected by the analysis engine 230, but alternatively may relate to less recent data, as will be explained later.

Stage 2 (S2). The analysis engine 230 then may query the data store 220 for related data, in order to set the data relating to the event in context. This related data may comprise both data related to historic events and contextual data 40.

Stage 3 (S3). The related data is received. At this stage a number of attributes may be calculated based on the related data to assist in further processing. Alternatively, previously calculated attributes may be saved in the data store 220, in which case they are recalculated based on any new information. These attributes may relate to the user involved, or may be static attributes related to the event or the object(s) involved in the event. User-related attributes may comprise distributions of activity types by time and/or location or a record of activity over a recent period (such as a 30 day sliding window average of user activity). Static attributes (or semi-static, and changing gradually over time) may comprise the typical number of machines used, the usual number of locations, devices used, browser preferences, and number of flagged events in the past.

Stage 4 (S4). The anomaly detection algorithm and neural net are then applied to the gathered data. Typically, three discrete tests are performed on the data (see Stage 4, Stage 5 and Stage 6), although the order that they are performed is interchangeable to a certain extent. The tests may be used to produce a score which may be compared against a number of thresholds in order to classify an event or series or events, as mentioned. The first test uses the anomaly detection algorithm and aims to find divergence between the tested event(s) and expected behaviour. A trained model is used to find the probability of the user to be active at the given time and performing the given activity—if it is found that the present event is significantly improbable, this may be a cause to flag the event as abnormal.

The probability of a combination of events occurring, such as a chain of events, is tested alongside the probability of an individual event occurring. A score for a combination of events may be produced in a simple case simply by combining the per event scores. New events can be determined to be part of a chain of events by a number of processes, including probability calculations related to the probability that two events occur one after the other and/or probability calculations using continuous time analysis to analyse the time differences between sequential events. Multiple chains of events may be occurring at once, such as when a user is multitasking. Multitasking behaviour can be determined by looking at the range of resources accessed by the user in a short time period (such as if the user is using two different browsers or making a phone call). Multitasking is a behaviour in itself which may indicate that the user is distracted or otherwise agitated, so this may be flagged and used in the analysis engine 230.

An example of an anomaly that can be revealed by considering a sequence of events is a user logging in shortly after that user has left the building; this could indicate a colleague hacking that user. Another example where a chain of malicious actions is identified (some of which might otherwise appear innocuous) is where multiple employees collaborate in order to leak data. Users who are working together are determined based on timing and clustering of actions, email exchanged, etc. (even taking breaks at the same time), and hence connected to a malicious event.

Stage 5 (S5). The data is also tested using additional constraints from contextual data 40. This may explain unexpected behaviour, or show that events which are not flagged by the test in Stage 4 are in fact abnormal. For example, it would be highly abnormal for the anomaly detection algorithm to detect that very few users are accessing most functions of the system on a Monday, unlike previous Mondays. However, when the contextual information of public holiday dates for the year is known, this behaviour can be easily rationalised. This information can be combined with further contextual information to provide more sophisticated information. For example, if information is provided relating to janitorial staff duties on public holidays, this can be used to check whether the number of users and the functions accessed deviate from what would be expected in this (relatively uncommon) scenario.

Stage 6 (S6). Malicious behaviour is typically determined differently from the determination of abnormal behaviour, because determining malicious behaviour involves testing events against models of possibly malicious events rather than investigating whether events performed differs from expected events performed. Operator feedback on whether abnormal events were malicious or not is important to improve the models of possibly malicious events, as is described in more detail below. As mentioned above, the analysis engine 230 may be trained based on a variety of different example scenarios. Events (or combinations of events) being analysed by the analysis engine 230 are tested against these scenarios using one or more of correlation, differential source analysis and likelihood calculations, which may be based on user or object history, type of action, events involving the user or object, or other events happening concurrently or close to the same time.

Stage 7 (S7). The volume of data collected and used by the log processing system 200 and the number of scenarios that could potentially be designated as ‘abnormal’ means that some number of false positive results are expected, particularly as it is expected that many operators of the log processing system 200 will prefer that the system 200 is sensitive, so as to mitigate the risk of any critical breaches being missed. To mitigate the problem of a high number of false positive results obscuring genuinely malicious behaviour, the analysis engine 230 may perform a ‘sense check’ on any outputs 30 marked as abnormal and/or malicious by re-running calculations and/or testing against previously identified scenarios. A ‘sense check’ can, for example, be an analysis on related events or a department level analysis. In an example, a user has a huge spike in activity, and so is behaving abnormally compared to his history; but if the department as a whole is displaying an activity spike, then the user's behaviour might not be abnormal. Abnormality may be evaluated against the current circumstances or a group of users, not just against historical data.

Operator feedback is useful in this regard. In an example where all support personnel are working late, this potentially abnormal behaviour might be not be malicious but due to an unknown circumstance that the analysis engine 230 has not taken into account (e.g. all engineers are performing updates after hours), but the potentially abnormal behaviour needs to be considered and classified as non-malicious by an operator. At this stage, the analysis engine 230 may calculate a confidence score for the output 30.

Stage 8 (S8). The operator decision (and, optionally, the results of any ‘sense checks’ based on related events) may be fed back into the learning algorithm, causing various parameters to change so as to reduce the probability that a non-malicious event similar to a previously marked false positive event is wrongly identified as malicious. This may comprise using an algorithm to update the parameters for all ‘neurons’ of the supervised neural net. Examples of approaches that could be used in this regard are AdaBoost, BackPropagation, and Ensemble Learning. The supervised neural net is thereby able to adapt based on feedback, improving the accuracy of outputs 30.

Stage 9 (S9). The results of the analysis engine's calculation and any outputs 30 produced may then be reported to an operator, as will be described later on. The results and/or outputs 30 are also saved into the data store 220.

It will be appreciated that the steps described above are merely an exemplary representation of the operation of the analysis engine 230 according to an embodiment, and alternative processing may be used in other embodiments. In particular, the described steps may be performed out of the described order or simultaneously, at least in part in other embodiments.

For the log processing system 200 to react quickly to breaches of the client system 100 or other malicious events, the analysis engine 230 needs to act on data that has been collected immediately prior to being received by the analysis engine 230, and optionally also when the data originates from devices that send log files 10 as that are generated. This minimises latency between malicious events occurring and the operator being alerted to them, along with reducing the risk of data being tampered with prior to processing. However, many malicious events are only identifiably malicious in the context of many other events or over a relatively long time scale. In addition, some log files 10 are not sent ‘live’, meaning that many events cannot immediately be sent in the context of other events if they are processed as soon as possible after being received by the log-ingesting server 210. In order to account for this data and to correctly find any suspicious ‘long timescale’ events, the analysis engine 230 is used to analyse collected data on a scheduled basis. This occurs in parallel with the analysis engine 230 being used to analyse ‘live’ data as described. Analyses may be made over several different time periods, and may be scheduled accordingly—for example, along with processing ‘live’ data, the analysis engine 230 may analyse data from the last 3 hours once an hour, data from the last 2 days once a day (such as overnight), data from the last month once a week, and so on. Some data might arrive with a delay (e.g. from scheduled or manually shipped logs) and its inclusion might impact the analysis. In order to take later arrived data into consideration, once the log-ingesting server 210 has ingested newly received delayed data, the combined (previously ingested) ‘live’ data and the newly received delayed data is replayed through the analysis engine 230. This way, further abnormal user interactions can be flagged that were not previously identified due to lack of data. This replaying is done in parallel with the live detection until it reaches real-time.

Detected interactions with elements of one part of the client system 100 may be used by the analysis engine 230 in combination with detected interactions with other elements of the system 100 to produce sophisticated insights about possible malicious activity. In relation to the example log processing described with reference to FIG. 3, the apparently innocuous event (“Jonathan logged into Salesforce”) may be examined in the context of other events related to the user and/or the object, which may reveal that there is something amiss. Some related events or insights produced from other events might include that Jonathan has never logged into Salesforce before, Jonathan logged in in France 10 minutes ago, Jonathan tried 20 different passwords before this successful login, Jonathan's other activities near the time are from a different IP address (denoting that he may be away from the office), Jonathan always uses a Mac rather than Windows, or that Jonathan has never logged in to Salesforce at this time or near this time before. All of these related events or insights may designate abnormality and/or maliciousness to some degree, but on their own may not be particularly note-worthy. However, if the analysis engine 230 is able to recognise that several of these events/insights are applicable, the threat of this log-in action increases heavily—for example, if Jonathan does not use Windows or Chrome, he does not seem to be in the office and 20 different passwords were tried before the detected successful log-in, then the events may be correlated to produce the inference that there are grounds for suspicion that an unauthorised person may be in the office and using Jonathan's credentials.

The association of a ‘profile’ for a given user, device, application or activity allows the analysis engine 230 to detect abnormal behaviour at a high level of granularity, enabling the detection of some potentially suspicious events such as a rarely used workstation experiencing a high level of activity with a rarely used application, or users suddenly starting to perform activities that they have never previously performed. As mentioned, additional contextual data 40 may also be used in order that the analysis engine 230 can take account of non-quantitative factors and use them to bias insights about whether abnormal behaviour is malicious. For example, if a contextual data 40 such as a psychological profile is inputted, a user may be characterised as an extrovert. Alternatively, a user may be automatically classified as an extrovert based on factors relating to their outgoing communications to other users, for example. This may then change certain parameter limits for determining whether an activity is suspicious. The log processing system 200 may then be able to detect whether a user is behaving out of character—for example, if the extrovert in the example above begins working at unsociable times when none of his or her colleagues are in the office, this may be combined with the insights that they are accessing files they do not typically access and that these behaviours are new to infer that the user may be acting maliciously and should be investigated.

Other assumptions produced from contextual data 40 (such as a user's job) may include that, generally, certain employees (i.e. users) do not work regular hours, while one group users with a certain role may tend to arrive at the office later than other users with another group of job types, and some individual employees tend to take long lunch breaks. A mix of generalisations can be compiled per job type (i.e. user groups), thus allowing for sudden changes of behaviour as compared to colleagues with the same job type to be easily detected. Similarly, it may be assumed that certain managerial roles interact with certain critical or confidential files or documents on shared storage space on a network on an infrequent basis, and almost never interact with other important documents. If this situation changes, it may indicate a compromised account as a malicious third party may have gained access to the manager's user credentials and may be using those credentials to acquire copies of important, confidential or critical files on the network.

In an example scenario of malicious activity that the log processing system 200 may be trained to recognise based on a psychological cue, it is known that users tend to pause for a short while before confirming a payment when buying something online, so as to review the transaction and assure themselves that they are spending their money wisely. An unauthorised user would not have such a strong incentive to pause and reflect, if any, and it has been noted that unauthorised users making online purchases typically pause for a much shorter period when their behaviour has been analysed. The significance of this ‘pause and reflect’ behaviour is detected via a signature in the time difference between two events, rather than in the timestamp of either event taken individually. This signature is usually specific to a user (for example a user's age influences the speed of action, to a degree), and a shorter pause can be indicative of a compromised user account/credentials or unauthorised user. An automated system posing as a user may act at super-human millisecond intervals for human tasks. In combination with other events, such as a non-typical log-in location or time, the lack of a short pause before confirming a transaction (as detected by the time between clicks on hyperlinks in a web browser or data requests being made for sequential web pages or data, for example) may indicate that an unauthorised person is using the user's credentials in this case. Distinctive time differences between events which are detectable in certain situations such as that described above may be fed into the analysis engine 230 as input data together with other data related to historic events and contextual data 40. The analysis engine 230 may be able to prioritise potentially threatening behaviours and/or events based on the determined probability that the observed behaviour is genuine malicious behaviour and any damage caused by that behaviour. The determination of risk may be through use of manually applied weightings (as additional contextual data 40) or may be made using weightings generated by the log processing system 200 and automatically applied to various kinds of activities, users, or documents to assist in this prioritisation. An overall risk score 122 may be calculated based on a combination of manually entered risk data and generated risk data. This risk data may be stored in the data store 220, whether associated with a ‘profile’ or otherwise. Generated risk data can be graph-based (that is, based on relationships between multiple object/users/events) and may comprise application sensitivity (for example, cloud storage is typically less secure than storage on secure local servers), ‘footprint’ of devices or objects (i.e. how many users access the device or object), permissions associated with users or a user's job role, frequency of similar malicious events and/or non-malicious events, and amount of resources available as a result of any breach.

Risk weightings may be at least partially configured by administrators of the client system 100 to be more or less strict, as some organisations (particularly those organisations handling large volumes of confidential data, for example) may be more concerned about the security of their systems than others.

Administrators may also provide feedback (for example, in the form of contextual data 40) about the risk and/or damage caused by identified malicious events. This feedback may be incorporated into the risk calculation and may cause saved risk data to be changed. Similar feedback may also be provided on whether results are false positives, which may then be incorporated into subsequent recalculations. Feedback on false positives may also be saved and used in future processing, particularly where the analysis engine 230 checks for false positives (see Stage 8, as previously described).

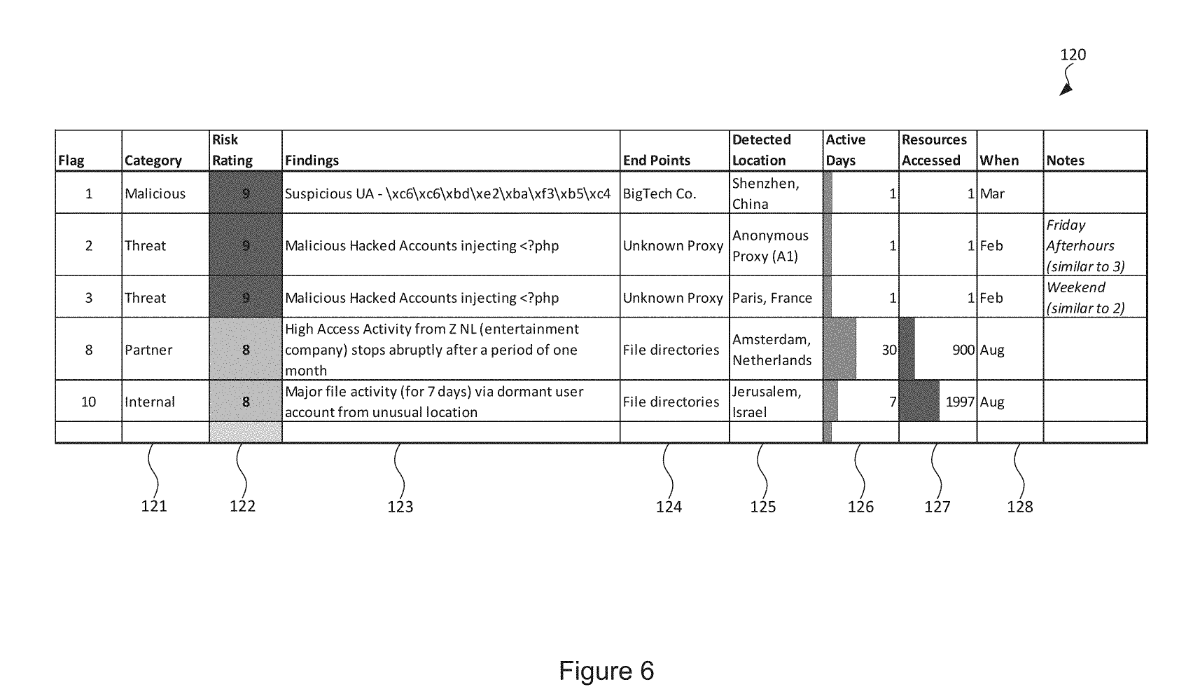

FIG. 6 shows an exemplary report 120 produced by the log processing system 200. Identified potential or current threats may then be investigated by the relevant person with responsibility for the security of the client system 100. A threat, in this context, should be taken to mean any event, series of events or behaviour which is potentially malicious. This report 120 may include potential threats (output from the analysis engine 230) in ranked order alongside a category 121, which may, for example, designate a threat as ‘malicious’, mere ‘threats’, relating to external partner activity, or relating to internal activity. The report 120 may also incorporate a risk score 122 calculated as previously described. Addition components of the report 120 may comprise a client system endpoint 124 (such as a device or application), location 125, and/or date 128 associated with the threat, a period 126 of time in which the threat or events associated with the threat has been active, a record of resources accessed 127 (if available), and a brief description of the findings 123. Other factors that potentially could be in the report include measures of confidence, notes or feedback fields and/or recommendations about possible ways to resolve threats—for example, one such recommendation could be ‘temporarily block user’. Reporting in this way allows effective prioritisation of resources within an organisation, which is further improved in that the sophistication of the system 200 as a whole reduces the number of false positives, saving further resources.

Where a high risk threat is detected as it is occurring, the log processing system 200 may be able to issue an alert via email, SMS, phone call or virtual assistant or another communication means. The system 200, if appropriately configured, may also be able to automatically implement one or more precautionary measures such as:
issuing a block on a user or device
blocking a session involving a user or device
suspending a user account
freezing user access
safeguarding resources e.g. initiate a system-wide backup.
performing a custom programmable action, such as an API call. This action may be configurable by the operator, and may be used, for example, to cancel an invoice to a third party in dependence on a threat being detected.

The thresholds at which these actions occur may be predetermined by the operator or may be dynamically determined based on operator preferences. In either case, the operator may be able to provide feedback about the action taken, which may be used to automatically adjust thresholds, thus improving the response of the system 200 to threats.

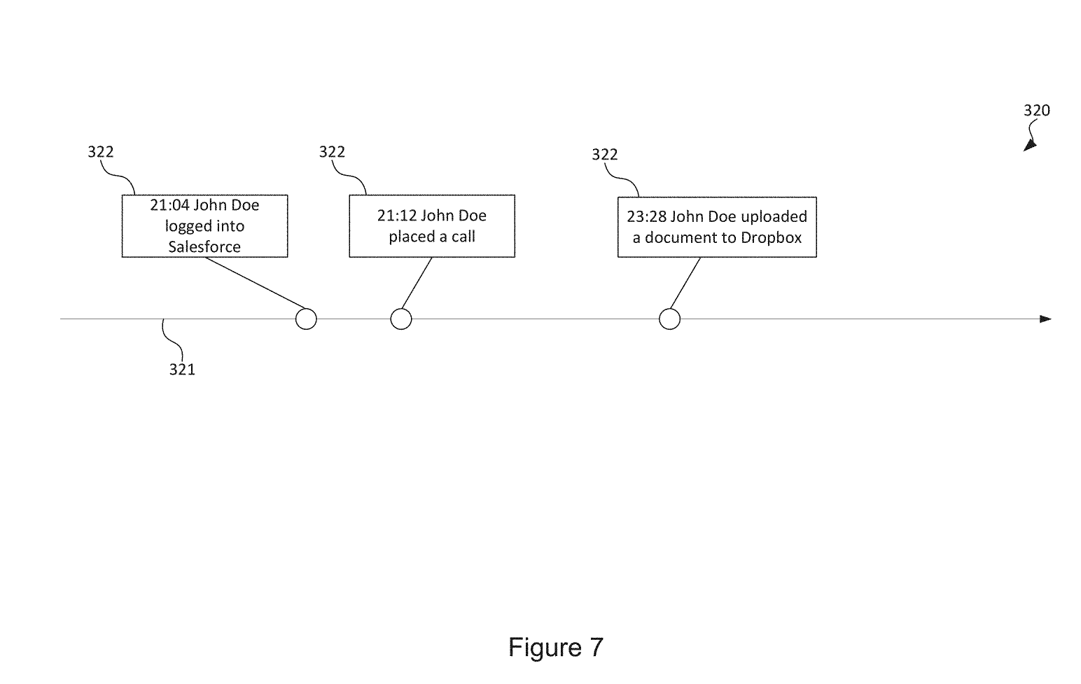

FIG. 7 shows a further exemplary report 320 produced by the log processing system 200. In the illustrated example the analysis engine provides a report of user John Doe's actions between 17:30 and 08:30. Identified events may then be reviewed by the relevant person. The report shows a timeline 321 with three events 322 occurring at different times. More information regarding the specific details of an event (such as a number called) can be provided. The events relating to a group of users can be superimposed on the same timeline, or on separate timelines, in order to review activity within a group. Events relating to an object, such as a shared laptop, can be provided either on their own or in combination with other events. Such a report may be used for security provision or otherwise.

Optionally, the log processing system 200 may interface with an online dashboard 110, which may be available through a web portal or a mobile application, which may show reports (as previously described) and allow live monitoring of the events detected in the log files 10. This dashboard 110 may comprise a map/location-based view showing all activity or relevant events on a map, graphs showing relationships between objects, tables and data around identified graphs, details about events and timelines of events, users or objects. The dashboard 110 preferably provides the ability for an administrator to explore objects, actions and users connected to events in a global context (to identify scale or possible impact, for instance). As such, the administrator may query the data store 220 using the dashboard. The dashboard 110 may also be used to set-up the log processing system 200, such as by allowing the input of additional information (such as contextual information), risk data or feedback, as previously described.

The log processing system 200 may also be able to further process the normalised log files 20 to new logs of events in human-readable format, using the ‘subject-verb-object’ processing described earlier. These new logs can be combined so as to show a user's workflow in the client system 100, and may be produced to show a sequence of events over a certain time period or for a certain user. Optionally, this feature extends to the provision of a unified timeline of a user's actions, or of actions involving an object, incorporating a plurality of new logs of events sorted by time. This feature is useful when conducting an after-event review of an occurrence such as a security breach, or for determining if a suspicious series of events is malicious or not, or for producing a record of events that can be used as evidence in a dispute. It may also be used to provide a description 123 of events in a report 120, or to interface with alert systems. Additionally, the analysis of events in a timeline manner can have other applications such as procedure improvements, personnel reviews, checks of work performed in highly regulated environments etc. Data can be expressed in a number of different ways depending on the detail required or available. With reference to the example described in relation to FIG. 3, this could include:

“Jonathan logged into Salesforce”

“Jonathan logged into Salesforce yesterday at 12:14”

“Jonathan logged into Salesforce yesterday at 12:14 from the Office”

“Jonathan logged into Salesforce yesterday at 12:14 from the Office using Chrome 20 on Windows 7”

The analysis engine 230 may be able to check the last log update from all or any data source, and recognise if latency has increased or if the system has failed. The log processing system 200 may then issue alerts appropriately.

As described above, a schema is manually defined for each data source to allow log files 10 form that data source to be processed. Alternatively, the functionality of the log-ingesting server 210 may extend to ingesting a file defining a schema for a specific data source, recognising it as such, and then automatically applying this schema to log files 10 received from, that data source.

The log processing system 200 may be used in combination with or integrate other security solutions, such as encryption systems and document storage systems.

Where data on a client system 100 is of the highest importance, such that cloud systems are not deemed to be sufficiently secure, a ‘local’ version of the log processing system 200 may be used, in which the log processing system 200 is integrated within the client system 100.

Although the log processing system 200 is configured for securing an IT system, its monitoring and predictive capabilities could also be used for several other purposes alongside performing its main role. For example, the progress (in terms of speed between actions, for example) of new starters leaning how to interact with a company's system could be monitored and areas that may require special attention flagged. Alternatively, abnormal (but not necessarily malicious) behaviour can be investigated to identify other scenarios which may be undesirable—such as users who are about to resign, or who are engaging in illegal behaviour (such as downloading copyrighted content using the client system 100).

It will be understood that the present invention has been described above purely by way of example, and modifications of detail can be made within the scope of the invention.

Each feature disclosed in the description, and (where appropriate) the claims and drawings may be provided independently or in any appropriate combination.

Reference numerals appearing in the claims are by way of illustration only and shall have no limiting effect on the scope of the claims.

What is claimed is:

1. A method for identifying abnormal user interactions within one or more monitored computer networks, comprising the steps of:
receiving metadata from one or more devices within the one or more monitored computer networks;
identifying from the metadata events corresponding to a plurality of user interactions with the monitored computer networks;
extracting relevant parameters from the metadata and mapping said relevant parameters to a common data schema, thereby creating normalised user interaction data;
storing the normalised user interaction event data from the identified said events corresponding to a plurality of user interactions with the monitored computer networks;
testing the normalised user interaction event data against a probabilistic model of expected user interactions to identify abnormal user interactions; and
updating said probabilistic model from said stored user interaction event data.

2. The method of claim 1, wherein the probabilistic model comprises one or more predetermined models developed from previously identified malicious user interaction scenarios and is operable to identify malicious user interactions.

3. The method of claim 1 or 2, wherein said user interaction event data comprises any or a combination of:
data related to a user involved in an event;
data related to an action performed in an event; and/or
data related to a device and/or application involved in an event.

4. The method of any preceding claim, wherein said common data schema comprises:
data identifying an action performed in an event; and
data identifying a user involved in an event and/or data identifying a device and/or application involved in an event.

5. The method of claim 4, wherein said common data schema further comprises any or a combination of:
data related to the or a user involved in an event;
data related to the or an action performed in an event; and/or
data related to the or a device and/or application involved in an event.

6. The method of any preceding claim, wherein the mapping comprises looking up a metadata schema and allocating the extracted relevant parameters to the common data schema on the basis of the metadata schema

7. The method of any preceding claim, further comprising the step of storing contextual data, wherein said contextual data is related to a user interaction event and/or any of: a user, an action, or an object involved in said event

8. The method of claim 7, wherein identifying from the metadata events corresponding to a plurality of user interactions further comprises identifying additional parameters by reference to contextual data.

9. The method according to claim 7 or 8, wherein the contextual data comprises data related to any one or more of: identity data, job roles, psychological profiles, risk ratings, working or usage patterns, action permissibility, and/or times and dates of events.

10. The method of any of claims 7 to 9, further comprising the step of testing the normalised user interaction event data against heuristics related to contextual data to identify abnormal and/or malicious user interactions.

11. The method of any of claims 7 to 10, wherein a trained artificial neural network is used to test the normalised user interaction event data against one or more predetermined models developed from previously identified malicious user interaction scenarios and the heuristics related to contextual data.

12. The method of any of claims 7 to 11, wherein the normalised user interaction event data and contextual data are stored in a graph database.

13. The method of claim 12, further comprising the step of storing metadata and/or the relevant parameters therefrom in an index database.

14. The method of any preceding claim, wherein testing the normalised user interaction event data against said probabilistic model comprises performing continuous time analysis.

15. The method of any preceding claim, further comprising the step of testing two or more sets of normalised user interaction event data against said probabilistic model to identify abnormal user interactions.

16. The method of claim 15, further comprising the step of determining whether said two or more of the sets of normalised user interaction event data are part of an identifiable sequence of user interactions indicative of user behaviour in performing an activity.

17. The method of claim 15 or claim 16, wherein the time difference between two or more of the sets of normalised user interaction event data is tested.

18. The method of claim 17, wherein the time difference is tested against the time difference of related historic user interactions.

19. The method of any preceding claim, further comprising the step of analysing the normalised user interaction data using a further one or more probabilistic model, the results of the probabilistic models being analysed by a higher level probabilistic model to identify higher level abnormal user interactions.

20. The method of any preceding claim, wherein receiving metadata comprises aggregating metadata at a single entry point.

21. The method of any preceding claim, wherein metadata is received at the device via one or more of a third party server instance, a client server within one or more computer networks, or a direct link with the one or more devices.

22. The method of any preceding claim, wherein each of the sets of normalised user interaction event data are tested for abnormality substantially immediately following said normalised user interaction event data being stored.

23. The method of claim 22, wherein normalised user interaction event data is tested for abnormality according to a predetermined schedule in parallel with other tests.

24. The method of claim 23, wherein testing for abnormality according to a predetermined schedule comprises analysing all available normalised user interaction event data corresponding to a plurality of user interactions with the monitored computer networks, wherein said plurality of user interactions occurred within a predetermined time period.

25. The method of any preceding claim, further comprising the step of calculating a score for the normalised user interaction event data based on one or more tests.

26. The method of claim 25, further comprising the step of classifying the normalised user interaction event data based on a comparison of calculated scores for the normalised user interaction event data in combination with one or more predetermined or dynamically calculated thresholds.

27. The method of claim 26, further comprising the step of prioritising any identified abnormal and/or malicious user interactions using calculated scores and the potential impact of the identified abnormal and/or malicious user interactions.

28. The method of any of claims 25 to 27, wherein the scores are calculated in additional dependence on one or more correlations between identified abnormal and/or malicious user interactions and one or more user interactions involving the user, action, and/or object involved in the identified abnormal and/or malicious user interactions.

29. The method of any of claims 2 to 28, further comprising the step of reporting identified abnormal and/or malicious user interactions.

30. The method of any of claims 2 to 28, further comprising the step of implementing precautionary measures in response to one or more identified abnormal and/or malicious user interactions, said precautionary measures comprising one or more of: issuing an alert, issuing a block on a user or device or a session involving said user or device, saving data, and/or performing a custom programmable action.

31. The method of any of claims 2 to 28, further comprising the step of receiving feedback related to the accuracy of the identification of the abnormal and/or malicious user interactions and updating the probabilistic model of expected user interactions and the one or more predetermined models developed from previously identified malicious user interaction scenarios in dependence on said feedback.

32. The method of any preceding claim, wherein metadata is extracted from one or more monitored computer networks via one or more of: an application programming interface, a stream from a file server, manual export, application proxy systems, active directory log-in systems, and/or physical data storage.

33. The method of any preceding claim, further comprising the step of generating human-readable information relating to user interaction events.

34. The method of claim 33, further comprising the step of presenting said information as part of a timeline.

35. Apparatus for identifying abnormal and/or malicious user interactions within one or more monitored computer networks, comprising:
a metadata-ingesting module configured to receive and aggregate metadata from one or more devices within the one or more monitored computer networks;
a data pipeline module configured to identify from the metadata events corresponding to a plurality of user interactions with the monitored computer networks;
a data store configured to store user interaction event data from the identified said events corresponding to a plurality of user interactions with the monitored computer networks; and
an analysis module comprising a probabilistic model of expected user interactions and an artificial neural network trained using one or more predetermined models developed from previously identified malicious user interaction scenarios, wherein the probabilistic model is updated from said stored user interaction event data;
wherein the analysis module is used to test the user interaction events to identify abnormal and/or malicious user interactions.

36. Apparatus according to claim 35, further comprising a user interface accessible via a web portal and/or mobile application.

37. Apparatus according to claim 36, wherein the user interface may be used to: view metrics, graphs and reports related to identified abnormal and/or malicious user interactions, query the data store, and/or provide feedback regarding identified abnormal and/or malicious user interactions.

38. Apparatus according to any or claims 35 to 37, further comprising a transfer module configured to aggregate and send at least a portion of the metadata from the one or more devices within the one or more monitored computer networks, wherein the transfer module is within the one or more monitored computer networks.

39. Apparatus according to any of claims 35 to 38, wherein the data pipeline module is further configured to normalise the plurality of user interactions using a common data schema.

40. Apparatus for carrying out the method of any of claims 1 to 34.

41. A computer program product comprising software code for carrying out the method of any of claims 1 to 34.

42. A method for identifying abnormal user interactions within one or more monitored computer networks, comprising the steps of:
receiving metadata from one or more devices within the one or more monitored computer networks;
identifying from the metadata events corresponding to a plurality of user interactions with the monitored computer networks;
storing user interaction event data from the identified said events corresponding to a plurality of user interactions with the monitored computer networks;
updating a probabilistic model of expected user interactions from said stored user interaction event data; and
testing each of said plurality of user interactions with the monitored computer networks against said probabilistic model to identify abnormal user interactions.

43. The method of claim 42, further comprising testing each of the plurality of user interactions with the monitored computer networks against one or more predetermined models developed from previously identified malicious user interaction scenarios to identify malicious user interactions.

44. The method of claim 42 or 43, wherein said user interaction event data comprises any or a combination of:
data related to a user involved in an event;
data related to an action performed in an event; and/or
data related to a device and/or application involved in an event.

45. The method of any of claims 42 to 44, wherein identifying from the metadata events corresponding to a plurality of user interactions with the monitored computer networks comprises extracting relevant parameters from computer and/or network device metadata and mapping said relevant parameters to a common data schema.

46. The method of claim 45, further comprising storing contextual data, wherein said contextual data is related to a user interaction event and/or any of: a user, an action, or an object involved in said event.

47. The method of claim 46, wherein identifying from the metadata events corresponding to a plurality of user interactions further comprises identifying additional parameters by reference to contextual data.

48. The method according to claim 46 or 47, wherein the contextual data comprises data related to any one or more of: identity data, job roles, psychological profiles, risk ratings, working or usage patterns, action permissibilities, and/or times and dates of events.

49. The method of any of claims 46 to 48, further comprising testing each of the plurality of user interactions with the monitored computer networks against heuristics related to contextual data to identify abnormal and/or malicious user interactions.

50. The method of any of claims 46 to 49, wherein a trained artificial neural network is used to test each of the plurality of user interactions with the monitored computer networks against the one or more predetermined models developed from previously identified malicious user interaction scenarios and the heuristics related to contextual data.

51. The method of any of claims 46 to 50, wherein user interaction event data and contextual data are stored in a graph database.

52. The method of claim 51, further comprising storing metadata and/or the relevant parameters therefrom in an index database.

53. The method of any of claims 42 to 52, wherein testing each of said plurality of user interactions with the monitored computer networks against said probabilistic model comprises performing continuous time analysis.

54. The method of any of claims 42 to 53, further comprising testing two or more of said plurality of user interactions in combination against said probabilistic model to identify abnormal user interactions.

55. The method of claim 54, further comprising the step of determining whether said two or more of the plurality of user interactions are part of an identifiable sequence of user interactions indicative of user behaviour in performing an activity.

56. The method of claim 54 or claim 55, wherein the time difference between two or more of said plurality of user interactions is tested.

57. The method of claim 56, wherein the time difference is tested against the time difference of related historic user interactions.

58. The method of any of claims 42 to 57, wherein receiving metadata comprises aggregating metadata at a single entry point.

59. The method of any of claims 42 to 58, wherein metadata is received at the device via one or more of a third party server instance, a client server within one or more computer networks, or a direct link with the one or more devices.

60. The method of any of claims 42 to 59, wherein each of the plurality of user interactions with the monitored computer networks are tested for abnormality substantially immediately following said user interaction event data being stored.

61. The method of claim 60, wherein each of the plurality of user interactions with the monitored computer networks are tested for abnormality according to a predetermined schedule in parallel with other tests.

62. The method of claim 61, wherein testing for abnormality according to a predetermined schedule comprises analysing all available user interaction data corresponding to a plurality of user interactions with the monitored computer networks, wherein said plurality of user interactions occurred within a predetermined time period.

63. The method of any of claims 42 to 62, further comprising calculating a score for each of the plurality of user interactions and/or a plurality of user interactions with the monitored computer networks based on one or more tests.

64. The method of claim 63, further comprising classifying each of the plurality of user interactions with the monitored computer networks based on a comparison of calculated scores for each of the plurality of user interactions and/or a plurality of user interactions in combination with one or more predetermined or dynamically calculated thresholds.

65. The method of claim 64, further comprising prioritising any identified abnormal and/or malicious user interactions using calculated scores and the potential impact of the identified abnormal and/or malicious user interactions.

66. The method of any of claims 63 to 65, wherein the scores are calculated in additional dependence on one or more correlations between identified abnormal and/or malicious user interactions and one or more user interactions involving the user, action, and/or object involved in the identified abnormal and/or malicious user interactions.

67. The method of any of claims 43 to 66, further comprising reporting identified abnormal and/or malicious user interactions.

68. The method of any of claims 43 to 67, further comprising implementing precautionary measures in response to one or more identified abnormal and/or malicious user interactions, said precautionary measures comprising one or more of: issuing an alert, issuing a block on a user or device or a session involving said user or device, saving data, and/or performing a custom programmable action.

69. The method of any of claims 43 to 68, further comprising receiving feedback related to the accuracy of the identification of the abnormal and/or malicious user interactions and updating the probabilistic model of expected user interactions and the one or more predetermined models developed from previously identified malicious user interaction scenarios in dependence on said feedback.

70. The method of any of claims 42 to 69, wherein metadata is extracted from one or more monitored computer networks via one or more of: an application programming interface, a stream from a file server, manual export, application proxy systems, active directory log-in systems, and/or physical data storage.

71. The method of any of claims 42 to 70, further comprising generating human-readable information relating to user interaction events.

72. The method of claim 71, further comprising presenting said information as part of a timeline.

73. A method for normalising metadata having a plurality of content schemata from one or more devices, within one or more monitored computer networks, comprising the steps of:
receiving metadata from the one or more devices within the one or more monitored computer networks;
extracting relevant parameters from the metadata and mapping said relevant parameters to a common data schema in order to identify events corresponding to a plurality of user interactions with the monitored computer networks; and
storing user interaction event data from the identified said events corresponding to a plurality of user interactions with the monitored computer networks.

74. The method of claim 73, wherein said common data schema comprises:
data identifying an action performed in an event; and
data identifying a user involved in an event and/or data identifying a device and/or application involved in an event.

75. The method of claim 73 or 74, wherein said common data schema further comprises any or a combination of:
data related to the or a user involved in an event;
data related to the or an action performed in an event; and/or
data related to the or a device and/or application involved in an event.

76. The method of any of claims 73 to 75, wherein the mapping comprises looking up a metadata schema and allocating the extracted relevant parameters to the common data schema on the basis of the metadata schema.

77. The method of any of claims 73 to 76, further comprising identifying additional parameters related to the metadata.

78. The method of claim 77, wherein the additional parameters are identified from a look-up table.

79. The method of claim 77 or 78, further comprising storing the additional parameters as part of the user interaction event data.

80. The method of any of claims 73 to 79, further comprising analysing the metadata.

81. The method of claim 80, wherein analysing comprises testing a first event against a second related event to identify a chain of related events.

82. The method of any of claims 73 to 81, further comprising reporting.

83. The method of claim 82, wherein reporting comprises compiling a sequence of one or more related events and providing data relating to those events.

84. The method claim 83, wherein the one or more related events relate to a particular time period.

85. The method of claim 83 or 84, further comprising providing said data as part of a timeline.

86. The method of any of claims 83 to 85, wherein the one or more related events relate to the same user, device, object, and/or chain.

87. The method of any of claims 82 to 86, wherein reporting comprises providing data relating to one or more events in the form of human-readable statements.

88. The method of any of claims 73 to 87, wherein receiving metadata comprises aggregating metadata at a single entry point.

89. The method of any of claims 73 to 88, wherein metadata is received via one or more of a third party server instance, a client server within one or more computer networks, or a direct link with the one or more devices.

90. The method of any of claims 73 to 89, wherein metadata is extracted from one or more monitored computer networks via one or more of: an application programming interface, a stream from a file server, manual export, application proxy systems, active directory log-in systems, and/or physical data storage.

91. The method of any of claims 73 to 90, wherein user interaction event data are stored in a graph database.

92. The method of any of claims 73 to 91, wherein user interaction event data are stored in an index database.

93. Apparatus for normalising metadata having a plurality of content schemata from one or more devices, within one or more monitored computer networks, comprising:
a metadata-ingesting module configured to receive and aggregate metadata from one or more devices within the one or more monitored computer networks;
a data pipeline module configured to extract relevant parameters from the metadata and map said relevant parameters to a common data schema in order to identify from the metadata events corresponding to a plurality of user interactions with the monitored computer networks; and
a data store configured to store user interaction event data from the identified said events corresponding to a plurality of user interactions with the monitored computer networks.

94. Apparatus according to claim 93, further comprising a user interface accessible via a web portal and/or mobile application.

95. Apparatus according to claim 94, wherein the user interface may be used to: view metrics, graphs and reports related to identified events, and/or query the data store.

96. Apparatus according any of claims 93 to 95, further comprising a transfer module configured to aggregate and send at least a portion of the metadata from the one or more devices within the one or more monitored computer networks, wherein the transfer module is within the one or more monitored computer networks.

97. Apparatus for carrying out the method of any of claims 73 to 92.

98. A computer program product comprising software code for carrying out the method of any of claims 73 to 92.

99. A method substantially as herein described and/or as illustrated with reference to the accompanying figures.

100. Apparatus substantially as herein described and/or as illustrated with reference to the accompanying figures.
